(19) United States
(12) Patent Application Publication
(10) Pub. No.: US 2015/0170702 A1
(43) Pub. Date: Jun. 18, 2015

(54) INFORMATION REPRODUCTION DEVICE AND METHOD OF PROVIDING CONTENT

(71) Applicant: Sharp Kabushiki Kaisha, Osaka (JP)

(72) Inventors: Takanobu SATO, Osaka-shi (JP); Hideharu TAJIMA, Osaka-shi (JP)

(21) Appl. No.: 14/626,965

(22) Filed: Feb. 20, 2015

Related U.S. Application Data
(63) Continuation of application No. 13/806,576, filed on Dec. 21, 2012.

(30) Foreign Application Priority Data
Jun. 29, 2010 (JP) 2010-148058

(51) Int. Cl. G11B 20/00; G06F 21/10; H04N 21/426; H04N 21/4627; H04N 5/76; H04N 5/931

(52) U.S. Cl. CPC G11B 20/00086; G11B 20/0013; G11B 20/00195; G11B 20/00253; G11B 20/00855; H04N 5/76; H04N 5/931; H04N 21/42684; H04N 21/4627; G06F 21/10; G11B 2220/2537; G06F 2221/0724

(57) ABSTRACT

Provided is an information reproduction device (10) that is connected to the content providing device (30) via the communication network (60). The information reproduction device (10) includes: a first identification information acquiring section (11) which acquires content identification information (501) that is unrewritable arbitrarily by a user and that is for identifying first content recorded on a recording medium (50); a second identification information acquiring section (12) which acquires terminal device identification information (421) that is unrewritable arbitrarily by a user and that is for identifying a terminal device (40) which receives a content; and a content transmission request section (13) which notifies the content providing device (30) of the content identification information (501) and the terminal device identification information (421) and which requests the content providing device (30) to transmit a content specified by the content identification information (501) and the terminal device identification information (421).

### TECHNICAL FIELD

The present invention relates to an information reproduction device, a content recording medium, a content providing system, a content providing method, and a control program. The present invention relates especially to a content providing technique of providing content via a communication network such as the Internet.

### BACKGROUND ART

Information reproduction devices, such as DVD recorders, HDD (Hard Disk Drive)-equipped DVD recorders, HDD recorders, BD (Blu-ray Disc; Registered Trademark) recorders, and HDD-equipped BD recorders, record content such as television programs and reproduce the content thus recorded.

Such information reproduction devices are capable of copying the recorded content onto mobile apparatuses such as mobile phones. A user who is carrying a mobile apparatus can watch, whenever and wherever he or she wants, a content copied from an information reproduction device onto the mobile apparatus.

In recent years, there are needs for a technique allowing a user to copy content from a content DVD (Digital Versatile Disc) or a content BD, on which content such as a movie is recorded, onto a mobile apparatus and to view content such as a content DVD with the use of the mobile apparatus. Such needs arise because of appearance of high-function mobile apparatuses that are capable of reproducing video.

The most important thing for achieving such needs is how to prevent content recorded on content DVDs and content BDs from illegally being copied onto mobile apparatuses free of charge. This is because such illegal copying from content DVDs and content BDs causes very serious problems such as copyright infringement and decline of sales of the content DVDs and content BDs.

Patent Literature 1, for example, proposes, as means for preventing illegal copying from music CDs (Compact Disks), a content providing method which prevents illegal copying from music CDs by using an identification number intrinsic to each disc in providing content.

According to this content providing method, an identification number intrinsic to each disc is given to a music CD when music data is recorded on the music CD. A user who purchased such a recording medium carries out a registration process via a network, and transmits the identification number to a management server of a content provider.

With the use of this identification number, the management server creates, for each user, a list indicative of songs possessed by the user. The user is permitted to play the songs possessed by the user in a user's mobile digital audio apparatus and to download the songs possessed by the user onto the apparatus free of charge or cheaply.

The user who purchased the music CD and completed the registration process is entitled to music distribution of the music CD. This makes it unnecessary for the user who wants to play the music in his or her mobile digital audio apparatus to copy the music data from the music CD.

By thus reducing opportunities for a user to copy music from a music CD onto a mobile apparatus, it is possible to prevent illegal copying from a music CD.

Also in the information reproduction device described above, use of the content providing method disclosed in Patent Literature 1 makes it possible to restrict users who are permitted to copy content recorded on a content DVD or a content BD onto a mobile apparatus to those who legally purchased the content DVD or the like.

That is, it is possible to prevent illegal copying of content DVDs and content BDs. As a result, it is possible to realize the needs for a technique allowing a user to view content such as a content DVD with the use of a mobile apparatus.

### CITATION LIST

### Patent Literature 1

Japanese Patent Application Publication, Tokukai, No. 2004-4245 A (Publication Date: Jan. 8, 2004)

### SUMMARY OF INVENTION

### Technical Problem

However, use of the content providing method disclosed in Patent Literature 1 causes the following problems.

First, according to the content providing method disclosed in Patent Literature 1, a user himself or herself needs to input an apparatus-intrinsic identification number for identifying a mobile digital audio apparatus. Such manual input is a bother for the user, and would incur incorrect input of an identification number. That is, the content providing method disclosed in Patent Literature 1 is undesirably inconvenient for a user.

Further, the manual input causes a problem that in a case where a user intentionally or negligently inputs an incorrect identification number, there is a risk that content is provided on the basis of the incorrect identification number.

Further, the identification number is information generally known to a user, such as a telephone number. This is because information that is generally unknown to a user cannot be used since the information manually inputted by the user needs to be easy to input. Even a third party who is not a legitimate user can know such an identification number. Accordingly, the content providing method disclosed in Patent Literature 1 also has a problem that there is a risk of unfair use of the identification number by a third party.

Further, in a case where a telephone number, from which a person can be easily identified, is used as the identification number, information leakage leads to leakage of personal information. This is a serious problem. In order to prevent this, high security is required. As a result, a cost necessary for system management becomes undesirably high.

Further, according to the content providing method disclosed in Patent Literature 1, both of a personal computer and a mobile digital audio apparatus need to be connected to a management server of a content provider via a network since it is necessary to carry out the registration process via the network. This undesirably requires both of (i) a cost for connection and communication of the personal computer with the network and (ii) a cost for connection and communication of the mobile digital audio apparatus with the network.

The present invention was attained in view of the above problems, and an object of the present invention is to provide an information reproduction device, a content recording medium, a content providing system, a content providing method, and a control program each of which makes it possible to improve convenience of a user and to prevent illegal copying of a content from a recording medium such as a content DVD or a content BD.

### Solution to Problem

In order to attain the above object, an information reproduction device of the present invention that is capable of reproducing information, includes illegal copying prevention means, the illegal copying prevention means including: information notification means for notifying a relevant program providing device of content identification information via a communication network, the relevant program providing device providing a relevant program that is relevant to content recorded on a recording medium, and the content identification information identifying the content recorded on the recording medium; relevant program receiving means for receiving the relevant program from the relevant program providing device; and terminal device identification information acquiring means for acquiring terminal device identification information that is unrewritable arbitrarily by a user, the terminal device identification information identifying a terminal device that is provided separately from the information reproduction device.

The information reproduction device is preferably arranged such that the illegal copying prevention means further includes recording medium identification information acquiring means for acquiring recording medium identification information that is unrewritable arbitrarily by the user, the recording medium identification information identifying the recording medium on which the content is recorded, and the information notification means notifies, as the content identification information, the relevant program providing device of the recording medium identification information acquired by the recording medium identification information acquiring means.

An information reproduction device of the present invention includes: information output means for supplying, to information notification means, (i) first identification information for identifying first content and (ii) second identification information for identifying a receiving device which receives second content that is relevant to the first content, the information notification means notifying, of information, a content providing device having a plurality of pieces of content; first identification information acquiring means for acquiring the first identification information that is unrewritable arbitrarily by a user; and second identification information acquiring means for acquiring second identification information that is unrewritable arbitrarily by the user.

The first identification information and the second identification information which are acquired by the information reproduction device are unrewritable arbitrarily by a user.

The “information that is unrewritable arbitrarily by a user” refers to information that cannot be rewritten by a general user who uses a device that can be purchased or means using information that can be acquired without any malicious intent.

That is, it is difficult for a third party to forge, counterfeit, and falsify both of the first identification information and the second identification information. This makes it possible to prevent a third party from illegally using the first identification information and the second identification information and illegally receiving the second content.

Further, since these two types of identification information that are difficult for a third party to falsify etc. are acquired without the need for any operation of the user, it is possible to eliminate the need for the manual input of the user, thereby improving convenience for the user.

Further, it is possible to prevent the user from mistakenly inputting incorrect identification information, thereby preventing unintentional misuse of the incorrect identification information.

A content recording medium of the present invention is a content recording medium that is portable by a user and has a region unrewritable arbitrarily by the user in which region first content and first identification information for identifying the first content are recorded, and said content recording medium having a recordable region in which information is recordable, in the recordable region, second identification information is recorded, the second identification information identifying a receiving device that is capable of reproducing second content that is relevant to the first content.

Since the second identification information is recorded on the content recording medium, it is unnecessary to acquire the second identification information again when a new second content becomes available and the second identification information becomes necessary.

This makes the user's operation easy, thereby improving convenience for the user.

A content providing system of the present invention includes: a content providing device that has a plurality of pieces of content and that provides one of the plurality of pieces of content via a communication network; and an information reproduction device including (i) information notification means for notifying, of information, the content providing device via the communication network and (ii) information output means for supplying information to the information notification means; said information reproduction device, further including: first identification information acquiring means for acquiring first identification information, which is unrewritable arbitrarily by a user, for identifying first content; and second identification information acquiring means for acquiring second identification information, which is unrewritable arbitrarily by the user, for identifying a receiving device which receives second content relevant to the first content, said content providing device including: a content database in which the plurality of pieces of content are stored; content selecting means for selecting, from the plurality of pieces of content, the second content specified based on the first identification information and the second identification information; and content transmitting means for transmitting, to the receiving device, the second content selected by the content selecting means, via the communication network.

According to the content providing system, the first identification information and the second identification information which are acquired by the information reproduction device are unrewritable arbitrarily by a user. Accordingly, it is difficult for a third party to forge, counterfeit, and falsify both of the first identification information and the second identification information arbitrarily.

Meanwhile, in the content providing device, the second content specified by the first identification information and the second identification information that are difficult for a third party to forge, counterfeit, and falsify arbitrarily is selected from the content database, and the second content thus selected is transmitted to the receiving device.

This makes it possible to prevent a third party from illegally using the first identification information and the second identification information and illegally receiving the second content.

Further, since these two types of identification information that are difficult for a third party to falsify etc. are acquired without the need for any operation of the user, it is possible to eliminate the need for the manual input of the user, thereby improving convenience for the user.

Further, it is possible to prevent the user from mistakenly inputting incorrect identification information, thereby preventing unintentional misuse of the incorrect identification information.

A method of the present invention for providing content with use of an information reproduction device which includes information output means for supplying information to information notification means for notifying, of information, a content providing device having a plurality of pieces of content, the method including the steps of: (a) acquiring first identification information, which is unrewritable arbitrarily by a user, for identifying first content; (b) acquiring second identification information, which is unrewritable arbitrarily by a user, for identifying a receiving device that receives second content relevant to the first content; and (c) notifying, via the information output means and the information notification means, the content providing device of the first identification information acquired in the step (a) and the second identification information acquired in the step (b), and requesting the content providing device to (i) select the second content from the plurality of pieces of content and (ii) transmit selected second content specified by the first identification information and the second identification information.

According to the method, the first identification information and the second identification information are unrewritable arbitrarily by a user. Accordingly, it is difficult for a third party to forge, counterfeit, and falsify both of the first identification information and the second identification information arbitrarily.

This makes it possible to prevent a third party from illegally using the first identification information and the second identification information and illegally receiving the second content.

Further, since these two types of identification information that are difficult for a third party to falsify etc. are acquired without the need for any operation of the user, it is possible to eliminate the need for the manual input of the user, thereby improving convenience for the user.

Further, it is possible to prevent the user from mistakenly inputting incorrect identification information, thereby preventing unintentional misuse of the incorrect identification information.

### Advantageous Effects of Invention

The information reproduction device of the present invention includes: information output means for supplying, to information notification means, (i) first identification information for identifying first content and (ii) second identification information for identifying a receiving device which receives second content that is relevant to the first content, the information notification means notifying, of information, a content providing device having a plurality of pieces of content; first identification information acquiring means for acquiring the first identification information that is unrewritable arbitrarily by a user; and second identification information acquiring means for acquiring second identification information that is unrewritable arbitrarily by the user.

It is thus possible to improve convenience for a user and to prevent illegal copying of a content from a recording medium such as a content DVD or a content BD.

### BRIEF DESCRIPTION OF DRAWINGS

FIG. 1 is a block diagram illustrating a configuration of a content providing system of an embodiment of the present invention.

FIG. 2 is a block diagram illustrating a hardware configuration of an information reproduction device in the content providing system.

FIG. 3 is a block diagram illustrating a hardware configuration of a content providing device in the content providing system.

FIG. 4 is a block diagram illustrating a hardware configuration of a terminal device in the content providing system.

FIG. 5 is a block diagram illustrating a configuration of a content providing system of another embodiment of the present invention.

FIG. 6 is a block diagram illustrating a configuration of a content providing system of another embodiment of the present invention.

FIG. 7 is a block diagram illustrating a configuration of a content providing system of another embodiment of the present invention.

FIG. 8 is a block diagram illustrating a configuration of a content providing system of another embodiment of the present invention.

FIG. 9 is an explanatory view illustrating a configuration of an identification information database of a content providing device in a content providing system of an embodiment of the present invention.

FIG. 10 is an explanatory view illustrating a configuration of a content database of the content providing device.

FIG. 11 is a flow chart explaining operations of an information reproduction device, a content providing device, and a terminal device in a content providing system of an embodiment of the present invention.

FIG. 12 is a block diagram illustrating a configuration of a content providing system of another embodiment of the present invention.

### DESCRIPTION OF EMBODIMENTS

The following description will discuss embodiments of the present invention with reference to the drawings. In the drawings, identical or similar parts are given respective identical or similar reference signs.

### Embodiment 1

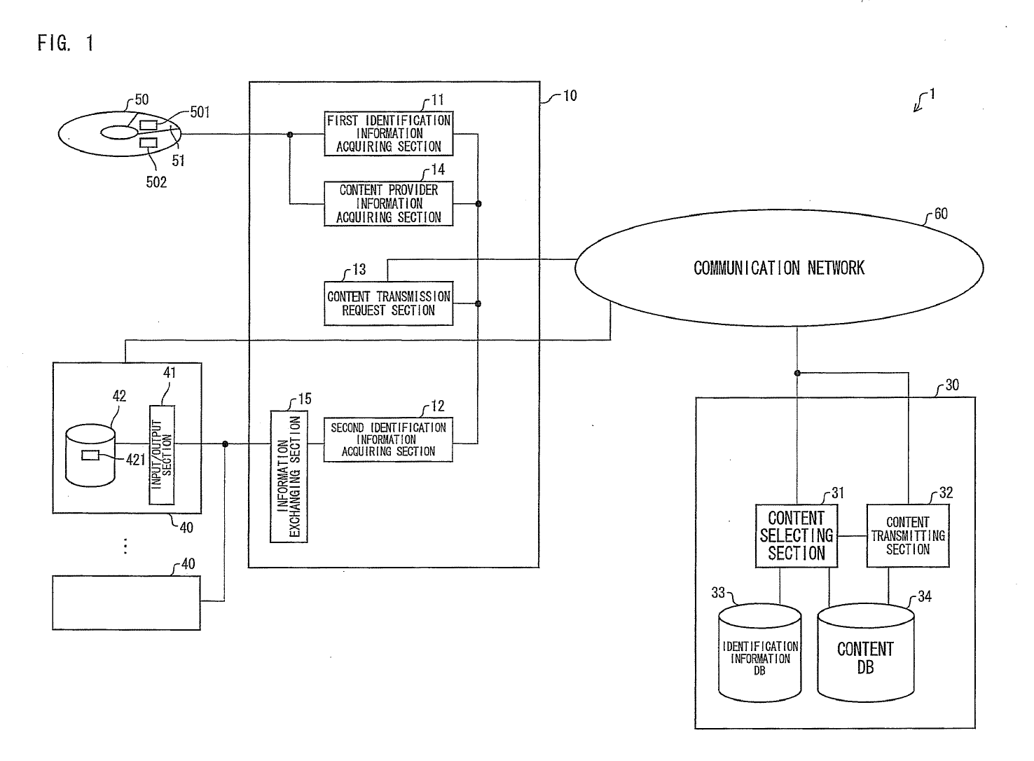

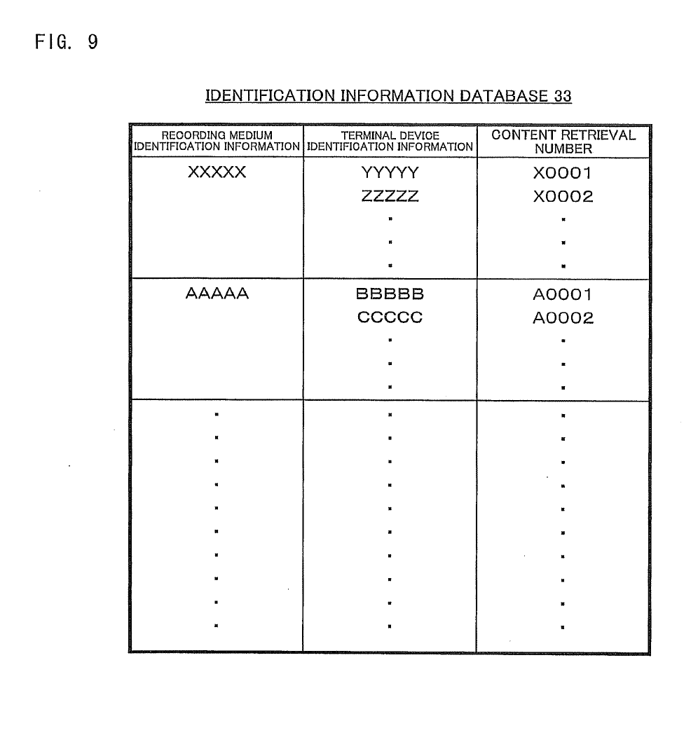

An embodiment of the present invention is described below with reference to FIG. 1 through FIG. 4, and FIG. 9 through FIG. 11.

(Content Providing System)

FIG. 1 is a block diagram showing a configuration of a content providing system 1 in accordance with Embodiment 1.

The content providing system 1 includes an information reproduction device 10, a communication network 60, a content providing device (relevant program providing device) 30, one or more terminal devices (receiving devices) 40, and a recording medium (content recording medium) 50 (see FIG. 1).

(Information Reproduction Device 10)

The information reproduction device 10 is connected to the content providing device 30 via the communication network 60. The information reproduction device 10 includes a first identification information acquiring section (first identification information acquiring means, content recording medium reproducing means, identification information recording medium reproducing means, recording medium identification information acquiring means) 11, a second identification information acquiring section (second identification information acquiring means, terminal device identification information acquiring means) 12, a content transmission request section (information output means, information notification means, network communication means) 13, a content provider information acquiring section (content provider information acquiring means) 14, and an information exchanging section (information exchanging means) 15. The information reproduction device 10 reproduces content. Note that the information reproduction device 10 can be an information reproduction device which doubles as reproducing of content and recording of content.

The information reproduction device 10 can further include relevant content receiving means (relevant program receiving means) for receiving relevant content from the content providing device 30.

To put it another way, the information reproduction device 10 includes illegal copying prevention means including each means described above, from the viewpoint of allowing prevention of illegal copying as described later.

The first identification information acquiring section acquires, from the recording medium 50, content identification information (first identification information) 501 for identifying first content recorded on the recording medium 50. Then, the first identification information acquiring section 11 supplies the content identification information 501 to the content transmission request section 13.

The second identification information acquiring section 12 acquires, from a terminal device 40 via the information exchanging section 15, terminal device identification information (second identification information, terminal identification information) 421 for identifying the terminal device 40. Then, the second identification information acquiring section 12 supplies the terminal device identification information 421 to the content transmission request section 13.

Upon receipt of (i) the content identification information 501 from the first identification information acquiring section 11 and (ii) the terminal device identification information 421 from the second identification information acquiring section 12, the content transmission request section 13 notifies, via the communication network 60, the content providing device 30 of the content identification information 501 and the terminal device identification information 421.

Note here that content (hereinafter referred to as “original content”) (the first content) is recorded, in advance, on the recording medium 50. One or more pieces of content relevant to the original content (hereinafter referred to as “relevant content”) (second content, a relevant program) are stored in the content providing device 30 for each piece of the original content recorded on the recording medium 50.

Examples of the original content encompass various pieces of content such as (i) pieces of picture information such as a TV program and a movie, (ii) music, (ii) game, (iv) image, (v) software, and (vi) program fields. A user is provided with such original content, which is recorded on the recording medium 50, through sales, for example.

Note that the original content and the content identification information 501 can be recorded in a content storage section (content storage region) of the information reproduction device 10 via, for example, a network. In this case, the first identification information acquiring section 11 acquires the content identification information 501 from the content storage section.

Meanwhile, the relevant content is not limited to a specific one, provided that it is relevant to such original content. Examples of the relevant content encompass (i) pieces of picture information such as a TV program and a movie, (ii) music, (iii) game, (iv) an image, (v) software, (vi) an advertisement, and (vii) web content.

For example, in a case where the original content recorded on the recording medium 50 is a movie, examples of the relevant content can encompass (i) compressed content obtained by compressing data of the movie so that the data can be reproduced by a portable device serving as the terminal device 40, (ii) an advertisement of the movie, and (iii) music.

Examples of the web content can further encompass (a) an SNS such as mixi in which only a holder of the recording medium 50 can participate and (b) Twitter which only the holder can follow.

Each relevant content is associated with (i) content identification information 501 for identifying corresponding original content and (ii) terminal device identification information 421 of a corresponding terminal device 40 which will receive the each relevant content. The each relevant content is specified in accordance with the two pieces of identification information (i) and (ii) (described later).

The content transmission request section 13 requests the content providing device 30 to select and transmit the each relevant content specified by the content identification information 501 and the terminal device identification information 421.

The content transmission request section 13 receives, from the content provider information acquiring section 14, content provider information for specifying a content providing device 30 to which the content transmission request section 13 is to be connected. In accordance with the content provider information, the content transmission request section 13 specifies the content providing device 30 to which the content transmission request section 13 is to be connected.

The content provider information acquiring section 14 acquires content provider information 502 (described earlier) from the recording medium 50, and then transmits the content provider information 502 to the content transmission request section 13. The content provider information 502 is an address on the communication network 60 which address is inherent to the content providing device 30. In a case where the communication network 60 is the Internet, for example, (i) an IP address which is assigned to a computer (node) that is connected to the Internet or (ii) a URL which is registered with DNS can be employed as the address. The address allows the content providing device 30 to be uniquely specified on the communication network 60.

Note that in order to record the content provider information 502 on the recording medium 50 in advance, the following issue should be addressed: it is necessary to carry out such recording before the user is provided with the recording medium 50. For example, a content provider, which manages and controls the content providing device 30, can address such an issue by concurrently recording, on the recording medium 50, (i) the content provider information 502 and (ii) the original content.

Note, however, that, even in a case where a content provider entrusts a third party with production and sales of the recording medium 50 without directly recording the original content and the content provider information 502 on the recording medium 50, content provider can address the above issue by providing the third party with the content provider information 502 and the original content.

Note that a single person does not necessarily need to record, on the recording medium 50, the content provider information and the original content. The point is that the content provider information is recorded on the recording medium 50 before the user is provided with the recording medium 50.

The information exchanging section 15 and the terminal device 40 make a mutual information exchange. The information exchanging section 15 is not limited to a specific one, provided that the information exchanging section 15 and the terminal device 40 can make a mutual information exchange, and it is therefore possible to employ wireless communication or wire communication. The information exchanging section 15 is not limited to a specific one, provided that it employs a short-distance information exchanging technique such as Bluetooth, infrared data communication, a USB, a cradle, an SD card, a touch IC card, or a non-touch IC card.

(Communication Network 60)

The communication network 60 is not limited to a specific one, provided that it can build an environment for a bidirectional digital line. Examples of the communication network 60 encompass the Internet, a broadband ISDN (Integrated Services Digital Network) telephone circuit, a city CATV network, a general public circuit, a wireless circuit, and Ethernet (Registered Trademark).

(Content Providing Device 30)

The content providing device 30 includes a content selecting section (content selecting means) 31, a content transmitting section (content transmitting means) 32, an identification information database (identification information DB) 33, and a content database (content DB) 34.

Upon receipt of content identification information 501 and terminal device identification information 421 from the content transmission request section 13 of the information reproduction device 10, the content selecting section 31 searches the identification information database 33, with the use of the content identification information 501 and the terminal device identification information 421. The identification information database 33 stores a content retrieval number which is associated with (a) the content identification information 501 and (b) the terminal device identification information 421.

The content selecting section 31 searches the identification information database 33 so as to acquire a content retrieval number which is associated with (a) the content identification information 501 and (b) the terminal device identification information 421. Next, the content selecting section 31 searches the content database 34, with the use of the content retrieval number. The content database 34 stores a plurality of pieces of the relevant content relevant to the original content which is recorded on the recording medium 50 in advance.

The content selecting section 31 searches the content database 34 so as to select a piece of the relevant content which corresponds to the content retrieval number. The content database 34 in turn supplies, to the content transmitting section 32, a selected piece of the relevant content.

The content transmitting section 32 acquires, from the content database 34, the selected piece of the relevant content. Then, the content transmitting section 32 transmits, to the information reproduction device 10 via the communication network 60, the piece of the relevant content acquired from the content database 34.

Note that the information reproduction device 10 transmits, to the terminal device 40 as it is, the relevant content which has been supplied from the content providing device 30 via the communication network 60. It goes without saying that the information reproduction device 10 receives the relevant content as it is, in a case where the information reproduction device 10 itself serves as the terminal device (receiving device) 40 (described earlier).

The information reproduction device 10 can use the information exchanging section 15 (described earlier) to transmit, to the terminal device 40, the relevant content received from the content providing device 30. Alternatively, the information reproduction device 10 can use a communication line other than the information exchanging section 15 to transmit the relevant content to the terminal device 40, the communication line being separately provided between the information reproduction device 10 and the terminal device 40.

The identification information database 33 stores a content retrieval number which is associated with (a) the terminal device identification information 421 and (b) the content identification information 501.

The content database 34 stores a plurality of pieces of the relevant content which are provided by the content providing device 30.

(Terminal Device 40)

The terminal device 40 receives the relevant content from the content providing device 30, and reproduces the relevant content thus received. The terminal device 40 can be integrated with or provided separately from the information reproduction device 10. Namely, the relevant content can be received from the content providing device by the information reproduction device 10 or the terminal device 40 which is provided separately from the information reproduction device 10. Note that the terminal device 40 can reproduce the relevant content, with the use of a content reproducing function of a portable publicly-known mobile terminal such as a mobile phone, a PC, a PDA, a portable game machine, or a portable player. Note also that the publicly-known mobile terminal does not need to be portable. Alternatively, the terminal device 40 can reproduce the relevant content, with the use of a content reproducing function of an electronic device such as a personal computer, a BD player, or a BD recorder each of which is provided separately from the information reproduction device 10.

The terminal device 40 includes an input/output section 41 and a terminal device identification information storage region 42.

The input/output section 41 and the information exchanging section 15 of the information reproduction device 10 make a mutual information exchange. The input/output section 41 is not limited to a specific one, provided that the input/output section 41 and the information reproduction device 10 can make a mutual information exchange, and it is therefore possible to employ wireless communication or wire communication. The input/output section 41 is not limited to a specific one, provided that it employs a short-distance information exchanging technique such as Bluetooth, infrared data communication, a USB, a cradle, an SD card, a touch IC card, or a non-touch IC card.

The second identification information acquiring section 12 of the information reproduction device 10 uses the information exchanging section 15 to request the input/output section 41 to transmit the terminal device identification information 421. In response to the request from the information exchanging section 15 to transmit the terminal device identification information 421, the input/output section 41 acquires the terminal device identification information 421 from the terminal device identification information storage region 42. Then, the input/output section 41 supplies the terminal device identification information 421 thus acquired to the information exchanging section 15.

The terminal device identification information storage region 42 is a storage region in which information cannot be rewritten because of hardware specifications or software setting and/or encryption. It is almost impossible for a third party to tamper information which is recorded in the terminal device identification information storage region 42. This assures reliability of the terminal device identification information 421 recorded in the terminal device identification information storage region 42.

That is, it can be said that the terminal device identification information 421 is information which cannot be arbitrarily rewritten by a user.

It is possible to employ, as the terminal device identification information storage region 42, a publicly-known IC chip which is employed in a touch IC card or a non-touch IC card. Such an IC chip is highly tamper-resistant, and has a characteristic such that information on the IC chip is difficult to illegally read and falsify. This allows enhancement of security of the terminal device identification information 421. It can be said that the terminal device identification information 421, which is recorded in the terminal device identification information storage region 42 as described above, is identification information which is difficult to counterfeit, falsify, or tamper.

The terminal device identification information 421 is identification information which is intended to identify the terminal device 40 and is inherent to the terminal device 40. In a case where the terminal device 40 is a mobile phone, it is preferable to employ, as the terminal device identification information 421, information which is intended to prevent duplication of the mobile phone, is undisclosed to the public, and restricts a user who can possess a reader. Alternatively, it is possible to employ, as the terminal device identification information 421, IMEI which is recorded on a publicly-known mobile phone, IMSI which is recorded on a publicly-known Sim card that is stored in a mobile phone, or IDm which is recorded on a publicly-known Felica chip that is provided in a mobile phone. Alternatively, it is possible to employ, as the terminal device identification information 421, not only publicly-known information but also unique identification information for carrying out the present invention. The above information is information which is normally unknowable not only to a third party but also to the user. It is therefore possible to greatly enhance security for the terminal device identification information 421, by employing such information as the terminal device identification information 421 and recording it in the terminal device identification information storage region 42 (described earlier).

Note here that the following description will discuss security measures taken in an information exchange between the information exchanging section 15 of the information reproduction device 10 and the input/output section 41 of the terminal device 40.

Security is required for delivery of the terminal device identification information 421 of the terminal device 40 to the information reproduction device 10. This is because the terminal device identification information 421 is used during identification or authentication for receiving service of provision of the relevant content from the content providing device 30.

According to a conventional content providing method described in Patent Literature 1, it is a user who manually enter an identification number which is intended to identify a portable digital audio device and is inherent to the portable digital audio device. Therefore, it is easy to counterfeit, falsify, or tamper the identification number. This can induce a third party to illegally acquire and use content.

And to make matters worse, the conventional content providing method allows a user to manually enter his/her identification number. It is therefore necessary for some users to use, as their respective identification numbers, information such as a phone number which is normally knowable to some other users. As a result, such identification numbers are also easily known to third parties. This also induces the third parties to illegally acquire and use content.

In contrast, according to the present embodiment, the terminal device identification information 421, such as IMEI, IMSI, or IDm, which is normally unknowable to others is stored in the terminal device identification information storage region 42 in which information can not be rewritten. The present embodiment can therefore prevent a third party from illegally acquiring and using content, unlike the conventional content providing method.

Note that it is preferable to carry out an encryption process with respect to delivery of the terminal device identification information 421 from the input/output section 41 to the information exchanging section 15. Examples of the encryption process encompass public key cryptosystem and symmetric-key cryptosystem. Since the terminal device 40 does not need to manage a secret key, the public key cryptosystem can ensure higher security.

(Hardware Configuration of Information Reproduction Device 10)

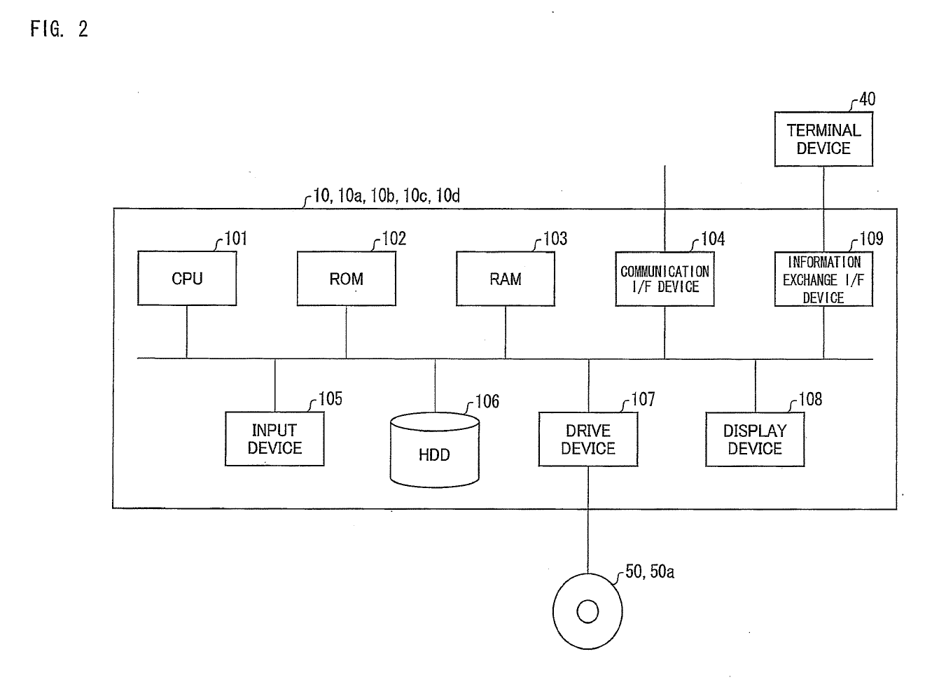

FIG. 2 is a block showing a hardware configuration of the information reproduction device 10. The information reproduction device 10 includes (i) a CPU 101 which processes commands of various programs, (ii) a ROM 102 in which for example, a control program of the information reproduction device 10 is stored, (iii) RAM 103 which temporarily (a) stores, for example, a result of calculation that is made by the CPU 101 and is still in progress and (b) allows high-speed writing/reading, (iv) a communication I/F device 104 which carries out communications with external devices, (v) an input device 105 which receives various instructions from a user, (vi) an HDD 106, (vii) a drive device 107 which receives information from the recording medium 50, and (viii) a display device 108 (see FIG. 2).

The CPU 101 carries out various processes in accordance with a program stored in the ROM 102, a program stored in the HDD 106, or a program stored in the RAM 103. The CPU 101 also temporarily stores data necessary for various processes in the RAM 103. The CPU 101 controls the entire information reproduction device 10.

The communication I/F device 104 carries out input/output processes to/from the communication network 60.

The input device 105 includes, for example, a numeric keypad and a keyboard, via which various instructions and/or data are entered by a user. The input device 105 stores, in the RAM 103 and the HDD 106, various instructions and/or data entered by the user. The user enters, via the input device 105, various instructions such as (i) an instruction causing data to be written into or read out from the recording medium 50 and (ii) an instruction causing information to be exchanged with the terminal device 40. The user can further enter, via the input device 105, pieces of information such as a user ID, a user password, a birth date, a sex, a job type, an address, and a name of the user (hereinafter referred to as “user information”). Other examples of the user information encompass an age, a job type, an income, a hobby, a type of content which the user desires to view, and hardware characteristics (e.g., a hard disk volume, a memory capacity, and the number of display pixels) of the terminal device 40 of the user.

The HDD 106 is constituted by, for example, a magnetic memory. The HDD 106 stores, for example, software which is a program group necessary for various processes that are carried out by the CPU 101. Note that programs constituting software necessary for various processes that are carried out by the CPU 101 can be incorporated in advance into a computer by dedicated hardware or can be alternatively provided by being incorporated in advance into the ROM 102 and/or the HDD 106. In a case where the original content and the content identification information 501 are stored in the content storage section (content storage region) of the information reproduction device 10, the HDD 106 can be used as a content storage section in which the original content and the content identification information 501 are stored.

Alternatively, the programs described above can be acquired from the recording medium 50. For example, the recording medium 50 or a memory card, in which the programs described above are stored, can be appropriately connected to the drive device 107 so that computer programs, which are read from the recording medium 50 or the memory card, are installed on the HDD 106 according to need.

The drive device 107 is appropriately connected with the recording medium 50, and acquires the original content and the content identification information 501 (described earlier) which are recorded in advance on the recording medium 50.

The display device 108 outputs various pieces of information (data). For example, the display device 108 is constituted by a display device such as an LCD (a liquid crystal display), a PDP (plasma display panel), or a CRT (cathode-ray tube).

An information exchange I/F device 109 is a communication I/F for establishing a connection with the terminal device 40. The information exchange I/F device 109, which is controlled by the CPU 101, constitutes a communication I/F (i.e., the information exchanging section 15) using Bluetooth, infrared data communication, a USB, a cradle, an SD card, a touch IC card, or a non-touch IC card (described earlier).

(Hardware Configuration of the Content Providing Device 30)

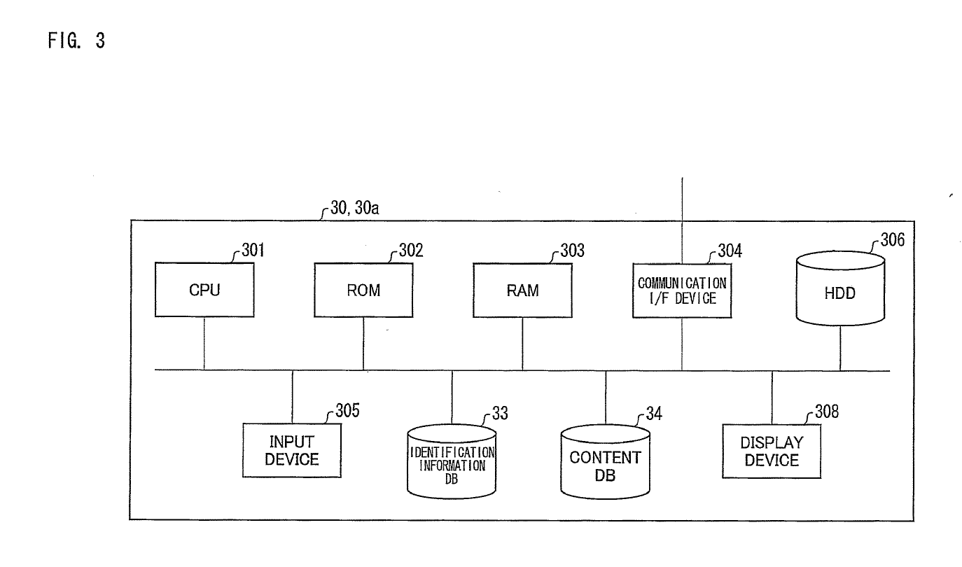

FIG. 3 is a block showing a hardware configuration of the content providing device 30. The content providing device 30 includes (i) a CPU 301 which processes commands of various programs, (ii) a ROM 302 in which for example, a control program of the content providing device 30 is stored, (iii) a RAM 303 which temporarily (a) stores, for example, a result of calculation that is made by the CPU 301 and is still in progress and (b) allows high-speed writing/reading, (iv) a communication I/F device 304 which carries out communications with external devices, (v) an input device 305 which receives various instructions from a user, (vi) an HDD 306, (vii) a display device 308, (viii) the identification information database 33, and (ix) the content database 34 (see FIG. 3).

The CPU 301 carries out various processes in accordance with a program stored in the ROM 302, a program stored in the HDD 306, or a program stored in the RAM 303. The CPU 301 also temporarily stores data necessary for various processes in the RAM 303. The CPU 301 controls the entire content providing device 30.

The communication I/F device 304 carries out input/output processes to/from the communication network 60.

The input device 305 includes, for example, a numeric keypad and a keyboard, via which various instructions and/or data are entered by a user. The input device 305 stores, in the RAM 303 and the HDD 306, various instructions and/or data entered by the user. The user enters, via the input device 305, an operation of, for example, access to the identification information database 33 and the content database 34.

The HDD 306 is constituted by, for example, a magnetic memory. The HDD 306 stores, for example, software which is a program group necessary for various processes that are carried out by the CPU 301. Note that programs constituting software necessary for various processes that are carried out by the CPU 301 can be incorporated in advance into a computer by dedicated hardware or can be alternatively provided by being incorporated in advance into the ROM 302 and/or the HDD 306.

The display device 308 outputs various pieces of information (data). For example, the display device 308 is constituted by a display device such as an LCD (a liquid crystal display), a PDP (plasma display panel), or a CRT (cathode-ray tube).

Each of the identification information database 33 and the content database 34 can be appropriately selected from publicly-known storage devices such as (i) a magnetic disk unit such as an HDD or (ii) a semiconductor memory. FIG. 1 and FIG. 3 show that the identification information database 33, the content database 34, and the HDD 306 are separate disk units. The present embodiment is, however, not to limited to this. Alternatively, the identification information database 33, the content database 34, and the HDD 306 can be stored in a single disk unit. A mutual correlation between respective pieces of data in each field can be realized by use of various file structures. For example, the identification information database 33, the content database 34, and the HDD 306 can be provided in different regions of a single file.

(Hardware Configuration of the Terminal Device 40)

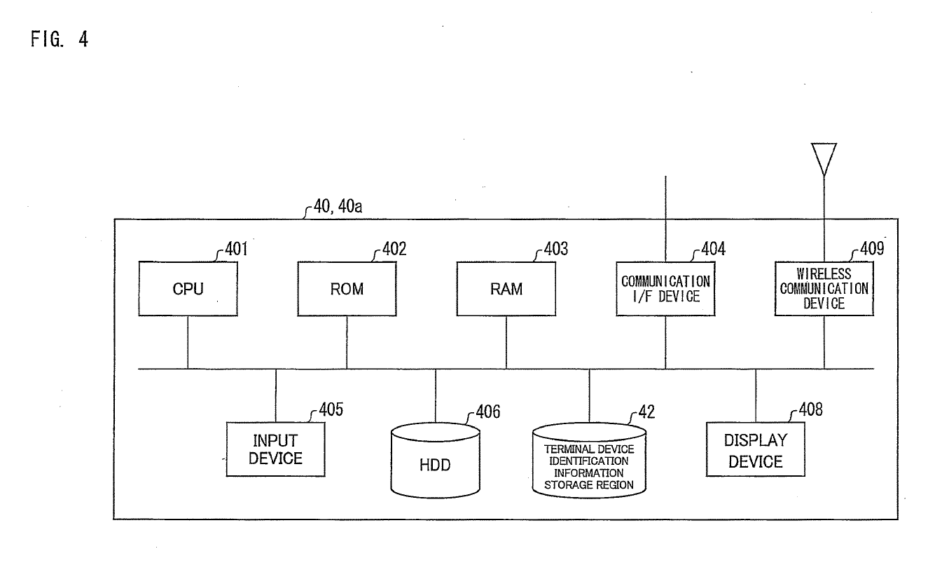

FIG. 4 is a block showing a hardware configuration of the terminal device 40. The terminal device 40 includes (i) a CPU 401 which processes commands of various programs, (ii) a ROM 402 in which for example, a control program of the terminal device 40 is stored, (iii) a RAM 403 which temporarily (a) stores, for example, a result of calculation that is made by the CPU 401 and is still in progress and (b) allows high-speed writing/reading, (iv) a communication I/F device 404 which carries out communications with external devices, (v) an input device 405 which receives various instructions from a user, an HDD 406, (vii) a display device 408, (viii) a wireless communication device 409 which carries out wireless communications with external devices, and (ix) a terminal device identification information storage region 42 (see FIG. 4).

The CPU 401 carries out various processes in accordance with a program stored in the ROM 402, a program stored in the HDD 406, or a program stored in the RAM 403. The CPU 401 also temporarily stores data necessary for various processes in the RAM 403. The CPU 401 controls the entire terminal device 40.

The communication I/F device 404 is a communication I/F for a connection with the information reproduction device 10. The communication I/F device 404, which is controlled by the CPU 401, constitutes a communication I/F using Bluetooth, infrared data communication, a USB, a cradle, an SD card, a touch IC card, or a non-touch IC card (described earlier), i.e., the input/output section 41.

The input device 405 includes, for example, a numeric keypad and a keyboard, via which various instructions and/or data are entered by a user. The input device 405 stores, in the RAM 403 and the HDD 406, various instructions and/or data entered by the user. The user enters via the input device 405, various instructions such as (i) an instruction causing the relevant content provided by the content providing device 30 to be reproduced and (ii) an instruction causing information to be exchanged with the information reproduction device 10.

The HDD 406 is constituted by, for example, a magnetic memory. The HDD 406 stores, for example, software which is a program group necessary for various processes that are carried out by the CPU 401. Note that programs constituting software necessary for various processes that are carried out by the CPU 401 can be incorporated in advance into a computer by dedicated hardware or can be alternatively provided by being incorporated in advance into the ROM 402 and/or the HDD 406.

The HDD 406 stores relevant pieces of content which are provided by the content providing device 30.

The display device 408 outputs various pieces of information (data). For example, the display device 408 is constituted by a display device such as an LCD (a liquid crystal display), a PDP (plasma display panel), or a CRT (cathode-ray tube). In accordance with an instruction from the user, the display device 408 displays the relevant content stored in the HDD 406.

The wireless communication device 409 includes (i) a detection section (not illustrated) which detects radio waves received via an antenna, (ii) an amplification section (not illustrated) which amplifies a detected analogue signal, and (iii) an A/D converter (not illustrated) which converts an amplified analogue signal to a digital signal. This allows the wireless communication device 409 to detect a wireless signal obtained by converting a received radio wave to a digital signal. The wireless communication device 409 can exchange information with an external device by use of such a wireless signal.

(Configuration of Recording Medium 50)

Examples of the recording medium 50 encompass (i) disks such as a magnetic disk, a magnet-optical disk, and an optical disk and (ii) a memory card such as a semiconductor memory. The present embodiment expects the recording medium 50 to have a capacity large enough to record pieces of content such as a movie on the recording medium 50. Therefore, the recording medium 50 is preferably a DVD (Digital Versatile Disc) or a BD (Blu-ray Disc; Registered Trademark) (described earlier).

The recording medium 50 has a content identification information storage region 51 in which the content identification information 501 is stored for identifying the original content recorded on the recording medium 50. Note that no information can be rewritten in the content identification information storage region 51. It is almost impossible for a third party to tamper information which is recorded in the content identification information storage region 51. This assures reliability of information recorded in the content identification information storage region 51.

That is, it can be said that the content identification information 501 is information which cannot be arbitrarily rewritten by a user.

It is possible to employ, as the recording medium 50, a publicly-known optical information recording medium such as a DVD or a BD having a multilayer structure in which at least two information recording layers are provided. Such an optical recording medium at least has an information recording layer in which various pieces of content are recorded in advance and which is a read-only information recording layer that can only be read (hereinafter referred to as a “ROM (Read Only Memory) layer”). The optical recording medium is a recording medium which has been improved in storage capacity. The optical recording medium can further have an information recording layer in which information is rewritable (hereinafter referred to as a “RE (REwritable) layer”) (described later).

The original content described earlier is recorded on the ROM layer.

The content identification information storage region 51 can be secured in, for example, the ROM layer. This is because the provision of the content identification information storage region 51 in the ROM layer causes the content identification information storage region 51 to be a read-only region, and therefore makes it almost impossible for a third party to tamper the content identification information 501.

An optical information recording medium as described above is normally provided with a bar-code management information region. The management information region contains a BCA (Burst Cutting Area) and PIC (Permanent Information & Control data). Especially, in the BCA, identification information indicative of a structure of the recording medium 50, an encryption key, and a decryption key are recorded in a bar-code pattern after production of the recording medium 50. Examples of the BCA encompass (i) a BCA of light transmission type in which an information recording layer itself of the recording medium 50 is vaporized by converging, for example, laser light having a great intensity onto the information recording layer so that an unrewritable bar code is prepared and (ii) a BCA of reflectance control type in which an information recording layer itself or its surrounding substrate is altered so that a change in amount of light reflected from an altered region.

It is possible to secure the content identification information storage region 51 in, for example, the BCA. This is because the provision of the content identification information storage region 51 in the BCA causes the content identification information storage region 51 to be a read-only region, and therefore makes it almost impossible for a third party to tamper the content identification information 501.

The content provider information 502 is recorded on the recording medium 50 (described earlier). The content provider information 502, together with the content identification information 501, can be recorded in the content identification information storage region 51. Alternatively, the content provider information 502 can be recorded in another region separately from the content identification information 501. The reason why the content provider information 502 can also be recorded in another region separately from the content identification information 501 is that the content provider information 502 is less likely to be counterfeited, falsified, or tampered.

Note that, in a case where the original content and the content identification information 501 are recorded in the content storage section of the information reproduction device 10, software, in which control and processing of the information reproduction device 10 are described, can be set so that a user cannot arbitrarily rewrite the software. In this case, it is almost impossible for a third party, who uses the information reproduction device 10, to tamper the content identification information 501.

Note also that (i) the original content which is to be recorded in the content storage section and (ii) the content identification information 501 can be encrypted so as to be recorded in the content storage section. In this case, even if the content storage section is isolated so as to be connected to another information reproduction device, it is impossible to read out the original content and the content identification information 501. This makes it almost impossible for a third party to tamper the content identification information 501.

(Identification Information Database 33)

FIG. 9 is an explanatory view showing a configuration of the identification information database 33. The identification information database 33 contains pieces of content identification information (recording medium identification information) 501 of the recording medium 50, pieces of terminal device identification information 421 of the terminal device 40, and content retrieval numbers each of which is associated with a corresponding one of the pieces of content identification information 501 and a corresponding one of the pieces of terminal device identification information 421.

In order to receive the relevant content from the content providing device 30, a user presents, to a content provider which manages and controls the content providing device 30, (i) content identification information 501 of the original content purchased by the user and (ii) terminal device identification information 421 of a terminal device 40 possessed by the user.

In accordance with the content identification information 501 presented by the user, the content provider can recognize contents of the original content.

The content provider recognizes the original content whose content identification information 501 has been presented by the user. Then, the content provider prepares a content retrieval number for retrieving, from the content database 34, the relevant content which is relevant to the original content.

The content retrieval number is a number for specifying the relevant content which is relevant to the original content. One (1) content retrieval number specifies one or more pieces of the relevant content.

(Content Database 34)

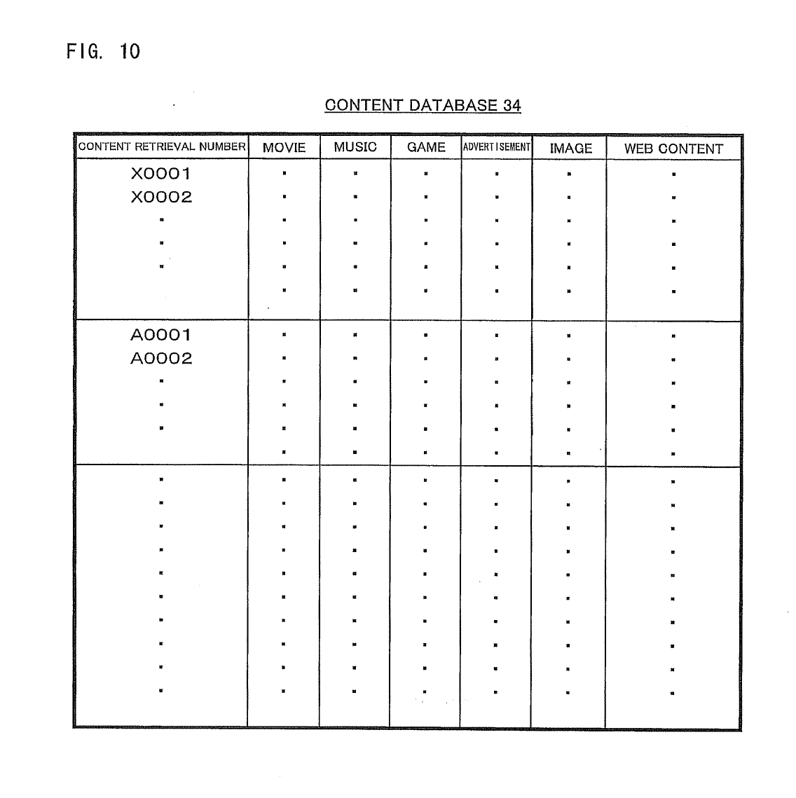

FIG. 10 is an explanatory view showing a configuration of the content database 34. The content database 34 contains (i) a content retrieval number and (ii) a movie, music, a game, an advertisement, an image, and web content each of which is associated with the content retrieval number.

In accordance with the contents of the original content, a content provider assigns the content retrieval number to content which is relevant to the original content, and then stores the content in the content database 34.

(Operations of the Information Reproduction Device 10, the Content Providing Device 30, and the Terminal Device 40)

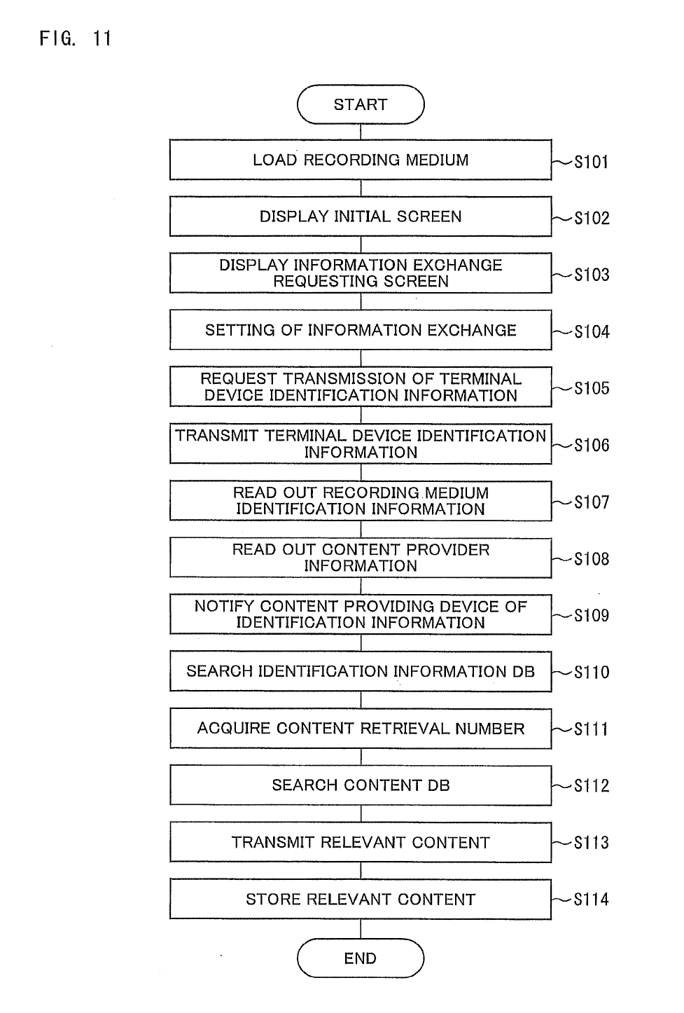

The following description will discuss operations of the information reproduction device 10, the content providing device 30, and the terminal device 40 with reference to FIG. 11.

First, a user loads the recording medium 50 into the information reproduction device 10 (step S101) (see FIG. 11). Then, the information reproduction device 10 causes the CPU 101 to read a program stored in the ROM 102 or the HDD 106 or a program recorded on the recording medium 50, and in accordance with a read program, the CPU 101 prepares a screen for instructing (i) a reproduction of the original content recorded on the recording medium 50 and (ii) start of content providing service (hereinafter referred to as an “initial screen”), and then controls the display device 108 to display the initial screen (step S102).

Next, in a case where the user enters, via the input device 105, an instruction as to selection of the start of content providing service, the CPU 101 prepares, in accordance with the program, a screen for requesting start of an information exchange between the information reproduction device 10 and the terminal device 40 (hereinafter referred to as an “information exchange requesting screen”), and then controls the display device 108 to display the information exchange requesting screen (step S103).

Subsequently, the user sets the information reproduction device 10 and the terminal device 40 so that an information exchange can be made between the information exchanging section 15 of the information reproduction device 10 and the input/output section 41 of the terminal device 40 (step S104). In the step S104, for example, the user sets, with the use of the input device 105 of the information reproduction device 10 and the input device 405 of the terminal device 40, the information reproduction device 10 and the terminal device 40 so that the information exchange can be made between the information exchanging section 15 and the input/output section 41.

Then, in a case where information becomes exchangeable between the information exchanging section of the information reproduction device 10 and the input/output section 41 of the terminal device 40, the second identification information acquiring section 12 of the information reproduction device 10 requests, with the use of the information exchanging section 15. the input/output section 41 of the terminal device 40 to transmit terminal device identification information 421 of the terminal device 40 (step S105). In response to the request to transmit the terminal device identification information 421 from the information exchanging section of the information reproduction device 10, the input/output section 41 of the terminal device 40 reads the terminal device identification information 421 from the terminal device identification information storage region 42, and then transmits the terminal device identification information 421 to the information exchanging section 15 (step S106). The second identification information acquiring section 12 acquires the terminal device identification information 421 via the information exchanging section 15, and then transmits the terminal device identification information 421 to the content transmission request section 13.

Meanwhile, the first identification information acquiring section 11 of the information reproduction device 10 reads the content identification information (recording medium identification information) 501 from the content identification information storage region 51 of the recording medium 50 (step S107). The content provider information acquiring section 14 of the information reproduction device 10 reads the content provider information 502 from the recording medium 50 (step S108). The first identification information acquiring section 11 transmits the content identification information 501 to the content transmission request section 13, and the content provider information acquiring section 14 transmits the content provider information 502 to the content transmission request section 13.

Next, in accordance with the content provider information 502 received from the content provider information acquiring section 14, the content transmission request section 13 specifies the content providing device 30 on the communication network 60. After the content transmission request section 13 has specified the content providing device 30, it notifies, via the communication network 60, the content providing device 30 of (i) the content identification information 501 supplied from the first identification information acquiring section 11 and (ii) the terminal device identification information 421 supplied from the second identification information acquiring section 12 (step S109). In the step S109, the content transmission request section 13 notifies the content providing device 30 of the content identification information 501 and the terminal device identification information 421, and requests the content providing device to transmit a piece of the relevant content to be specified by the content identification information 501 and the terminal device identification information 421.

Note that it is preferable that the user cannot (i) confirm the content identification information 501 and the terminal device identification information 421 and (ii) use the content identification information 501 and the terminal device identification information 421 except for using them during notification to the content providing device 30. This can further prevent these pieces of the identification information from leaking to a third party and consequently from being illegally used by the third party.

Subsequently, upon receipt of the content identification information 501 and the terminal device identification information 421 from the content transmission request section 13 of the information reproduction device 10, the content selecting section 31 of the content providing device 30 carries out a search for the identification information database 33 in accordance with the content identification information 501 and the terminal device identification information 421 thus received (step S110).

Next, the content selecting section 31 acquires a hit content retrieval number during such a search (step S111). Then, based on the content retrieval number acquired from the identification information database 33, the content selecting section 31 carries out a search for the content database 34 (step S112). In the step S112, the content selecting section 31 causes the content database 34 to supply a hit piece of the relevant content to the content transmitting section 32.

The content transmitting section 32 transmits, to the terminal device 40 via the communication network 60 and the information reproduction device 10, the relevant content received from the content database 34 (step S113). In the step S113, the information reproduction device 10 temporarily receives the relevant content transmitted via the communication network 60, and then transmits, via the information exchanging section 15, the relevant content to the input/output section 41 of the terminal device 40.

Note that the relevant content can be reproduced only by the terminal device 40 which the information reproduction device 10 has notified of the terminal device identification information 421. In this case, it is possible to use a publicly-known digital copyright management technique.

Finally, the input/output section 41 of the terminal device 40 stores, in the HDD 406, the relevant content received via the information exchanging section 15 (step S114). In the step 114, in a case where the user enters, via the input device 405, an instruction on reproducing of the relevant content, the CPU 401 reproduces the relevant content in accordance with a program stored in the ROM 402 or the HDD 406, and controls the display device 408 to display the relevant content.

### Embodiment 2

The following description will discuss Embodiment 2 of the present invention.

According to Embodiment 1, the content identification information 501 for identifying the first content is used.

In contrast, according to Embodiment 2, recording medium identification information (distributed content identification information) for identifying a recording medium 50 is used. Note that the recording medium identification information is recorded on an individual recording medium 50 to be distributed or sold.

A content providing system of Embodiment 2 is different from the content providing system 1 of Embodiment 1 in that Embodiment 2 uses, instead of the content identification information 501, recording medium identification information (distributed content identification information) for identifying a recording medium 50, which is recorded on an individual recording medium 50 to be distributed or sold. With the configuration, a content provider can limit the number of terminal devices 40 which can receive provision of relevant content, by (i) storing, in an identification information database 33 of a content providing device 30, the recording medium identification information and terminal device identification information 421 so that the recording medium identification information and the terminal device identification information 421 are associated with each other and (ii) setting a limited number of pieces of the terminal device identification information 421 which are associated with one (1) piece of recording medium identification information, it is possible to. It goes without saying that it is possible (i) to set no limited number of pieces of the terminal device identification information 421 which are associated with one (1) piece of recording medium identification information and (ii) not to limit the number of terminal devices 40 which can receive provision of relevant content. This is because it is sometimes preferable to provide more terminal devices 40 with relevant content such as an advertisement relevant to original content.

A first identification information acquiring section 11 of an information reproduction device 10 acquires, from a recording medium 50, the recording medium identification information for identifying the recording medium 50. Then, the first identification information acquiring section 11 supplies the recording medium identification information to a content transmission request section 13.

The recording medium identification information, which is recorded on an individual recording medium 50 to be distributed or sold, is intended to identify a recording medium 50. For example, in a case where the recording medium 50 is an optical information recording medium, identification information recorded on a BCA can be employed as the recording medium identification information.

Note that, in a case where the original content is distributed or sold via a network or the like and is recorded in a content storage section of the information reproduction device 10, distributed content identification information, which is individually supplied every time the original content is distributed, can be recorded, as the recording medium identification information, in the content storage section together with the original content.

Upon receipt of (i) the recording medium identification information from the first identification information acquiring section 11 and (ii) the terminal device identification information 421 from a second identification information acquiring section 12, the content transmission request section 13 notifies, via a communication network 60, the content providing device 30 of the recording medium identification information and the terminal device identification information 421.

A limited number of pieces of terminal device identification information 421 which are associated with one (1) piece of the recording medium identification information is set in the identification information database 33 of the content providing device 30 which receives such a notification. That is, terminal devices 40 which are associated with one (1) recording medium 50 are limited in number. For example, in a case where the limited number is “4”, it is possible to associate not more than 4 pieces of terminal device identification information 421 with one (1) piece of recording medium identification information. It is therefore possible to associate 4 terminal devices 40 with one (1) recording medium 50.

In a case where the number of pieces of terminal device identification information 421 which are associated with notified recording medium identification information does not exceed the limited number, the content providing device 30, which has been notified of recording medium identification information and terminal device identification information 421, newly stores notified recording medium identification information and notified terminal device identification information 421 in the identification information database 33 so that the recording medium identification information and the terminal device identification information 421 are associated with each other. Then, the content providing device 30 retrieves and specifies the relevant content, and then transmits the relevant content to each of the terminal devices 40 via the information reproduction device 10. Also in a case where the recording medium identification information and the terminal device identification information 421 of which the content providing device 30 has been notified are already stored in the identification information database 33 so as to be associated with each other, the content providing device 30 retrieves and specifies the relevant content, and transmits the relevant content to each of the terminal devices 40 via the information reproduction device 10.

In a case where the number of pieces of terminal device identification information 421 which are associated with one (1) piece of the recording medium identification information exceeds the limited number, the content selecting section 31 suspends a search for the identification information database 33, and reports the suspension to a content transmitting section 32. Meanwhile, in a case where the recording medium identification information which has been notified from the content transmission request section 13 is not stored in the identification information database 33, the content selecting section 31 suspends the search of the identification information database 33, and reports the suspension to the content transmitting section 32. This is because the recording medium identification information, which has been received from the content transmission request section 13, appears to be illegal in this case. The content transmitting section 32, to which the suspension of the search was reported, notifies, via the communication network 60, the content transmission request section 13 that no relevant content would be transmitted.

Note that based on the recording medium identification information presented by a user, the content provider can recognize contents of the original content recorded on the recording medium 50 on which the recording medium identification information is recorded.

This is because for example, when providing the original content to a subcontractor for production and sales of the recording medium 50, the content provider can acquire the recording medium identification information of the recording medium 50 on which the original content is recorded. It goes without saying that it is easy for the content provider, who produces and sells the recording medium 50, to recognize the contents of the original content from the recording medium identification information of the recording medium 50.

Therefore, the content provider can recognize the original content recorded on the recording medium 50 to which the recording medium identification information has been presented, and can prepare a content retrieval number for retrieving, from a content database 34, relevant content relevant to the original content.

The content provider thus limits the number of pieces of terminal device identification information 421 which are associated with One (1) piece of the recording medium identification information. This can prevent unnecessary provision of the relevant content which is recorded on the recording medium 50 and is relevant to the original content. As a result, it is possible to reduce an opportunity to induce illegal copying of the relevant content. Further, since the relevant content is provided to limited destinations, it is unnecessary to provide excessive security for prevention of illegal copying of the relevant content. Furthermore, user's convenience is improved. This is because a process for user identification and authentication can be reduced.

### Embodiment 3

The following description will discuss Embodiment 3 of the present invention.

According to Embodiment 1, in a case where the information reproduction device 10 requests the content providing device 30 to transmit the relevant content, the content providing device 30 transmits, in response to the request, the relevant content to the terminal device 40 via the information reproduction device 10.

In contrast, according to Embodiment 3, in a case where an information reproduction device 10a requests a content providing device 30 to transmit relevant content, the content providing device 30 transmits the relevant content directly to a terminal device 40, i.e., not via the information reproduction device 10a.

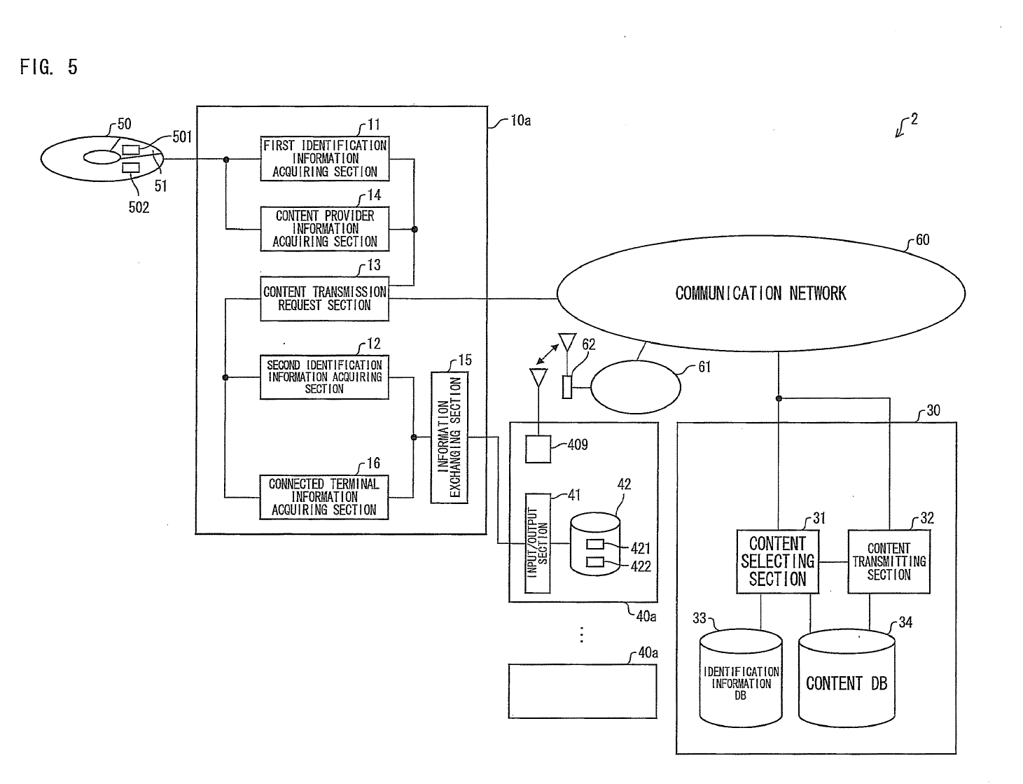

FIG. 5 is a block diagram showing how a content providing system is configured in Embodiment 3. In the following description, parts/sections which are similar to those of Embodiments 1 and 2 are given respective identical reference signs, and their specific description is omitted.

A content providing system 2 of Embodiment 3 is different from the content providing system 1 of Embodiment 1 in that an information reproduction device 10a further includes a connected terminal information acquiring section (connected receiving device information acquiring means) 16 which acquires connected terminal information (connected receiving device information) 422 that is an address on a communication network 60 which address is inherent to a terminal device 40a (see FIG. 5). This allows the content providing device 30 to transmit the relevant content directly to the terminal device 40a. It goes without saying that as in the case of Embodiment 1, the relevant content can also be transmitted indirectly to the terminal device 40a via the information reproduction device 10a in accordance with an instruction from a user. This is because it is sometimes preferable for the relevant content to be transmitted via the information reproduction device 10a in terms of security measures and a data volume of the relevant content.

The connected terminal information acquiring section 16 of the information reproduction device 10a uses an information exchanging section 15 to acquire the connected terminal information 422 of the terminal device 40a from the terminal device 40a, and transmits the connected terminal information 422 to a content transmission request section 13.

The content transmission request section 13 notifies, via the communication network 60, the content providing device 30 of the connected terminal information 422 together with content identification information 501 and terminal device identification information 421.

The connected terminal information 422 is an address on the communication network 60 which address is unique to the terminal device 40a. For example, in a case where the communication network 60 is the Internet, it is only necessary to use, as the address, an IP address which is assigned to a computer (node) that is connected to the Internet. In a case where the terminal device 40a is a mobile phone, it is only necessary to use an E-mail address of the mobile phone. The terminal device 40a is uniquely specified on the communication network 60 by the address.

Note that the terminal device 40a actually wirelessly communicates with a wireless base station 62 which is connected to a data communication network 61 that is connected to the communication network 60. The terminal device 40a uses the wireless communication device 409 (see FIG. 4) to wirelessly communicate with the wireless base station 62. Therefore, the connected terminal information 422 (described earlier) is the address on the data communication network 61 from the communication network 60, the address being unique to the terminal device 40a. For example, a telecommunication carrier, who manages and controls the data communication network 61, connects the data communication network 61 to the communication network 60 via a provider (not illustrated). For example, the provider includes (i) a router which is an intermediary device on the communication network 60, (ii) a gateway for combining heterogeneous networks, and (iii) the like. It goes without saying that the data communication network 61 and the communication network 60 may be directly connected to each other.

The terminal device 40a uses the wireless communication device 409 (see FIG. 4) to wirelessly communicate with the wireless base station 62 on the data communication network 61. Namely, the terminal device 40a has a wireless communication function.

Note that the terminal device 40a does not necessarily need to have the wireless communication function, and may have a wire communication function.

A terminal device identification information storage region 42 of the terminal device 40a stores the connected terminal information 422 (described earlier). In response to a request from the information exchanging section 15 of the information reproduction device 10a to transmit the connected terminal information 422, an input/output section 41 of the terminal device 40a acquires the connected terminal information 422 from the terminal device identification information storage region 42. Then, the input/output section 41 supplies the connected terminal information 422 to the information exchanging section 15.

Note that the connected terminal information 422 may be recorded in a region different from the terminal device identification information storage region 42. This is because the connected terminal information 422 is less likely to be counterfeited, falsified, or tampered. In this case, it is only necessary to, for example, record the connected terminal information 422 on a HDD 406 or a ROM 402.

A content transmitting section 32 of the content providing device 30 receives the connected terminal information 422 from the content transmission request section 13 of the information reproduction device 10a. In accordance with the connected terminal information 422 thus received, the content transmitting section 32 specifies the terminal device 40a as a destination of the relevant content. Then, the content transmitting section 32 transmits, to the terminal device 40a via the communication network 60, the data communication network 61, and the wireless base station 62, the relevant content selected by a content selecting section 31.

Note that the content providing device 30 can transmit guidance information (e.g., an E-mail in which a URL is described) to the content providing device 30, instead of the relevant content (described earlier). In this case, in accordance with the guidance information, the terminal device 40a can be connected directly to the content providing device 30 via the wireless base station 62, the data communication network 61, and the communication network 60. This allows the content providing device 30 to offer the following content providing service. According to content providing service, the content providing device 30 (i) matches (a) the terminal device identification information 421 which has already been notified by the information reproduction device 10a with (b) the terminal device identification information 421 which is notified by the terminal device 40a and (ii) permits provision of the relevant content only in a case where the above (a) matches the above (b).

### Embodiment 4

The following description will discuss Embodiment 4 of the present invention.

According to Embodiment 1, the information reproduction device 10 has a function of reproducing the recording medium 50 and acquires the content identification information 501 from the recording medium 50.

Differently from Embodiment 1, according to Embodiment 4, an information reproduction device acquires content identification information 501 from an information reproduction device (first content reproduction device) 80 that is provided separately from the information reproduction device and that is capable of reading out information from a recording medium 50.

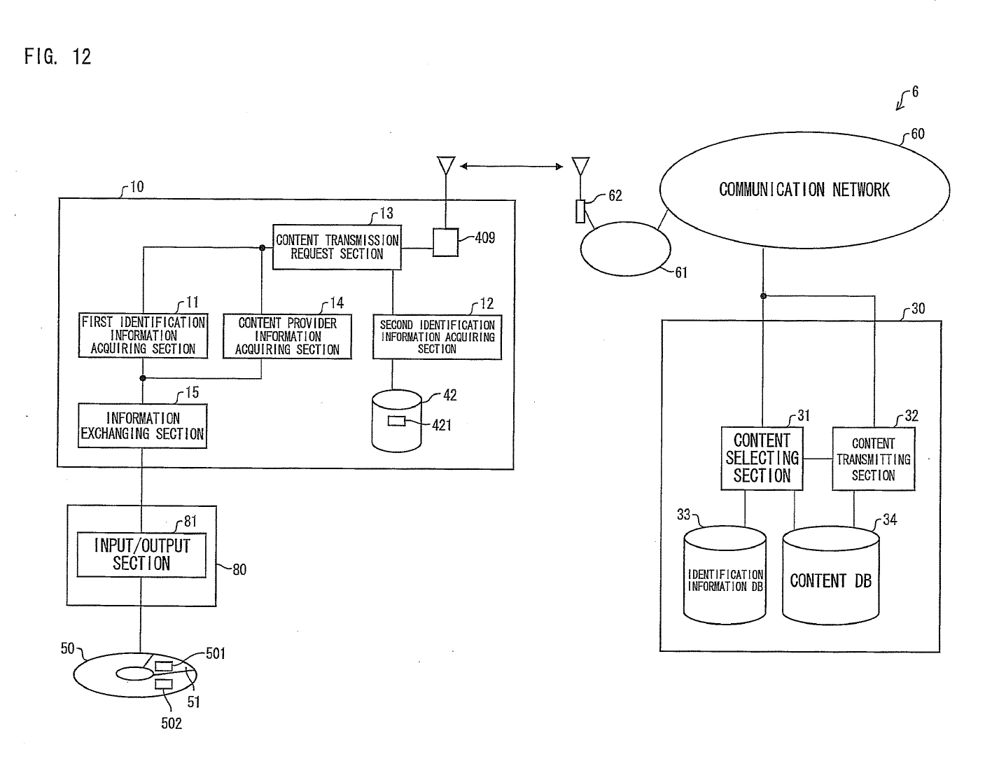

FIG. 12 is a block diagram showing how a content providing system is configured in Embodiment 4. Members that are similar to those of Embodiments 1 through 3 are given identical reference numerals, and are not described in detail.

As is clear form FIG. 12, a content providing system 6 of Embodiment 4 is different from the content, providing system 1 of Embodiment 1 in that a first identification information acquiring section 11 of and a content provider information acquiring section 14 of an information reproduction device 10 respectively acquire content identification information 501 and content provider information 502, via an information exchanging section 15, from the information reproduction device 80 that is provided separately from the information reproduction device 10. This eliminates the need for the information reproduction device 10 to have the function of reproducing the recording medium 50. It is therefore possible to use the information reproduction device 10 as a portable mobile terminal.

The information reproduction device 80 reads out the content identification information 501 and the content provider information 502 from the recording medium 50, and supplies the content identification information 501 and the content provider information 502 to the information exchanging section 15 of the information reproduction device 10 via an input/output section 81.

The input/output section 81 of the information reproduction device 80 is not limited in particular, provided that it is capable of exchanging information with the information reproduction device 10. Examples of the input/output section 81 encompass one employing a wireless communication and one employing a wired communication. For example, the input/output section is not limited to a specific one, provided that it employs a short-range information exchange technique such as Bluetooth, infrared data communication, a USB, a cradle, an SD card, a touch IC card, or a non-touch IC card.

The first identification information acquiring section of and the content provider information acquiring section 14 of the information reproduction device 10 acquire the content identification information 501 and the content provider information 502, respectively, via the information exchanging section 15, and supplies them to a content transmission request section 13.

The second identification information acquiring section 12 of the information reproduction device 10 acquires terminal device identification information 421 from a terminal device identification information storage region 42, and supplies the terminal device identification information 421 thus acquired to the content transmission request section 13.

FIG. 12 shows a case where the terminal device is integral with the information reproduction device 10. Note, however, that the terminal device can be provided separately from the information reproduction device 10, as has been described in Embodiment 1.

Upon receipt of (i) the content identification information 501 from the first identification information acquiring section 11 and (ii) the terminal device identification information 421 from the second identification information acquiring section 12, the content transmission request section 13 specifies, on the basis of the content provider information 502, the content providing device 30 to which the content transmission request section 13 is connected, and then notifies, via a communication network 60, the content providing device 30 of the content identification information 501 and the terminal device identification information 421.

The information reproduction device 10 can have a wireless communication device 409 (see FIG. 12) which wirelessly communicates with a wireless base station 62 that is connected to a data communication network 61 to be connected to the communication network 60. This allows a user of the information reproduction device 10 to (i) carry the information reproduction device 10 and to notify the content providing device 30 of the content identification information 501 and the terminal device identification information 421 and (ii) acquire a relevant content anytime and anywhere.

### Embodiment 5

The following description will discuss Embodiment 5 of the present invention. According to Embodiment 5, a user sets user information concerning the user with the use of an information reproduction device 10b, and then the information reproduction device 10b transmits the user information to the content providing device 30.

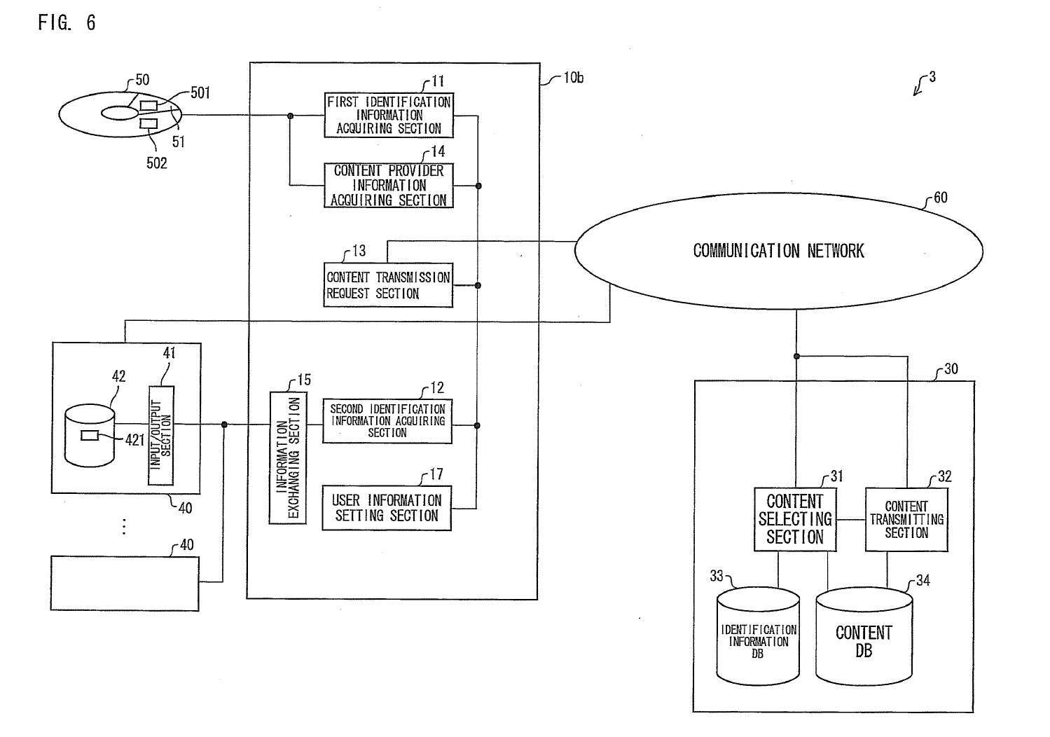

FIG. 6 is a block diagram showing how a content providing system is configured in Embodiment 5. Members that are similar to those of Embodiments 1 through 4 are given identical reference numerals, and are not described in detail.

As is clear from FIG. 6, a content providing system 3 of the present embodiment 5 is different from the content providing system 1 of Embodiment 1 in that the information reproduction device 10b further includes a user information setting section 17 for setting user information entered by a user.

As described above, a user enters, via an input device 105 (see FIG. 2), user information such as user ID, user password, user's date of birth, sex, job type, address, and name.

The user information setting section 17 transmits, to a content transmission request section 13, the user information thus entered. The content transmission request section 13 concurrently notifies, via a communication network 60, a content providing device 30 of the user information when notifying the content providing device 30 of content identification information 501 and terminal device identification information 421.

A content selecting section 31 of the content providing device 30 receives the user information from the content transmission request section 13 of the information reproduction device 10b, and uses the user information in searching identification information database 33 on the basis of the content identification information 501 and the terminal device identification information 421 so as to select a relevant content suitable for the user.

The content selecting section 31 can select a relevant content, suitable for the user, such as a relevant content that is similar to the original content recorded on the recording medium 50 and that is in line with the user's preference and/or advertisement of the relevant content.

### Embodiment 6

The following description will discuss Embodiment 6 of the present invention.

According to Embodiment 1, in a case where the information reproduction device 10 notifies the content providing device 30a of the terminal device identification information 421 and the content identification information 501, the information reproduction device 10 transmits, to the content providing device 30a via the communication network 60, the terminal device identification information 421 and the content identification information 501 without encrypting them.

In contrast, according to Embodiment 6, an information reproduction device 10c (i) encrypts terminal device identification information 421 and content identification information 501 before notifying a content providing device 30a of the terminal device identification information 421 and the content identification information 501 and (ii) transmits encrypted terminal device identification information 421 and encrypted content identification information 501 to the content providing device 30a via a recording medium 50a and a communication network 60.

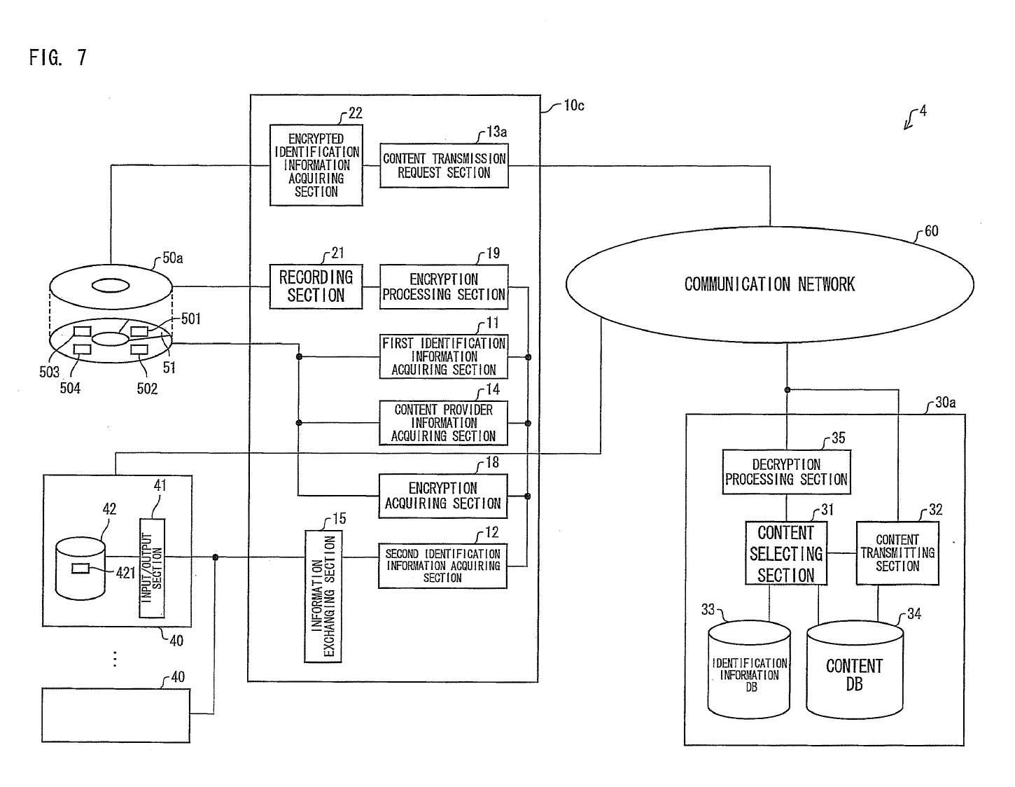

FIG. 7 is a block diagram showing how a content providing system is configured in Embodiment 6. Members that are similar to those of Embodiments 1 through 5 are given identical reference numerals, and are not described in detail.

As is clear from FIG. 7, a content providing system 4 of the present embodiment 6 is different from the content providing system 1 of Embodiment 1 in that the information reproduction device 10c further includes: (i) an encryption acquiring section (encryption acquiring means) 18 for acquiring an encryption key 503 and an encryption algorism 504 from a recording medium 50a (identification information recording medium); (ii) an encryption processing section 19 for encrypting the terminal device identification information 421 and the content identification information 501 with the use of the encryption key 503 and the encryption algorism 504; (iii) a recording section 21 (identification information recording medium recording means) for recording, on the recording medium 50a, the encrypted terminal device identification information 421 and the encrypted content identification information 501; and (iv) an encrypted identification information acquiring section 22 for acquiring, from the recording medium 50a, the encrypted terminal device identification information 421 and the encrypted content identification information 501.

Furthermore, the content providing system 4 of the present embodiment 6 is different from the content providing system 1 of Embodiment 1 in that the content providing device 30a further includes a decryption processing section (decryption processing means) 35 for decrypting the encrypted terminal device identification information 421 and the encrypted content identification information 501.

Note that the recording medium 50a has an RE layer on which information is rewritably recorded, in addition to the ROM layer. Furthermore, the encryption key 503 and the encryption algorism 504 are recorded on the ROM layer of the recording medium 50a.

The encryption acquiring section 18 of the information reproduction device 10c acquires the encryption key 503 and the encryption algorism 504 from the recording medium 50a. Then, the encryption acquiring section 18 supplies, to the encryption processing section 19, the encryption key 503 and the encryption algorism 504.

According to Embodiment 6, a first identification information acquiring section 11 acquires, from the recording medium 50a, the content identification information 501 for identifying the original content, and then supplies the content identification information 501 to the encryption processing section 19. A second identification information acquiring section 12 acquires, from the terminal device 40 with the use of the information exchanging section 15, the terminal device identification information 421 for identifying the terminal device 40, and then supplies the terminal device identification information 421 to the encryption processing section 19. A content provider information acquiring section 14 acquires the content provider information 502 from the recording medium 50a, and then supplies the content provider information 502 to the encryption processing section 19.

The encryption processing section 19 encrypts the terminal device identification information 421 and the content identification information 501 with the use of the encryption key 503 and the encryption algorism 504 so as to generate encrypted terminal device identification information 421 and encrypted content identification information 501. During the encryption, the encryption processing section 19 transmits, to the recording section 21, the content provider information 502 acquired from the content provider information acquiring section 14 as it is without any encryption.

The encryption processing section 19 transmits, to the recording section 21, the encrypted terminal device identification information 421, the encrypted content identification information 501, and the content provider information 502. The recording section 21 receives, from the encryption processing section 19, the encrypted terminal device identification information 421, the encrypted content identification information 501, and the content provider information 502, and records them on the RE layer of the recording medium 50a.

The encrypted identification information acquiring section 22 acquires, from the RE layer of the recording medium 50a, the encrypted terminal device identification information 421, the encrypted content identification information 501, and the content provider information 502, and then transmits them to a content transmission request section 13a.

The content transmission request section 13a specifies the content providing device 30a on the basis of the content provider information 502 supplied from the encrypted identification information acquiring section 22, and then notifies the encrypted content providing device 30a of the terminal device identification information 421 and the encrypted content identification information 501.

Note that, after the content transmission request section 13a notifies the content providing device 30a of the encrypted terminal device identification information 421 and the encrypted content identification information 501, the terminal device identification information 421 and the content identification information 501 that are temporarily recorded on the RAM 103 when the encryption processing section 19 encrypts the terminal device identification information 421 and the content identification information 501 are deleted. This causes the terminal device identification information 421 and the content identification information 501 not to remain in the information reproduction device 10c. Consequently, even if the information reproduction device 10c is stolen etc., there is no possibility that the terminal device identification information 421 and the content identification information 501 are illegally read from the information reproduction device 10c by a third party.

Note that Embodiment 6 is not limited to the configuration in which the content identification information 501 and the content provider information 502 are recorded on the RE layer of the recording medium 50a. An alternative configuration can be employed in which (i) the terminal device identification information 421 and (ii) the content identification information 501 that have been encrypted by the encryption processing section 19, and (iii) the content provider information 502 are directly transmitted to the content transmission request section 13a.

Note also that Embodiment 6 is not limited to the configuration in which the recording section 21 records, on the RE layer of the recording medium 50a, the terminal device identification information 421, the content identification information 501, and the content provider information 502. An alternative configuration can be employed in which the recording section 21 records, on a rewritable medium that is provided separately from the recording medium 50a, (i) terminal device identification information 421, (ii) content identification information 501 that are, supplied from the encryption processing section 19 and have been encrypted, and (iii) content provider information 502. In such an alternative configuration, the encrypted identification information acquiring section 22 acquires, from the rewritable medium, encrypted terminal device identification information 421, encrypted content identification information 501, and the content provider information 502, and then transmits them to the content transmission request section 13a.

Upon receipt of the encrypted terminal device identification information 421 and the encrypted content identification information 501, the decryption processing section 35 of the content providing device 30a decrypts the encrypted terminal device identification information 421 and the encrypted content identification information 501, with the use of a decryption key and a decryption algorism that are recorded, for example, on the ROM 302 or the HDD 306 (see FIG. 3). Then, the decryption processing section 35 transmits, to the content selecting section 31, decrypted terminal device identification information 421 and decrypted content identification information 501.

### Embodiment 7

The following description will discuss Embodiment 7 of the present invention. Embodiment 7 is different from Embodiments 1 through 6 in that there are provided (i) an information reproduction device 10d which acquires (a) terminal device identification information 421 from a terminal device 40a and (b) content identification information 501 from a recording medium 50a and (ii) an information reproduction device (information notification means) 70 which notifies a content providing device 30a of the terminal device identification information 421 and the content identification information 501.

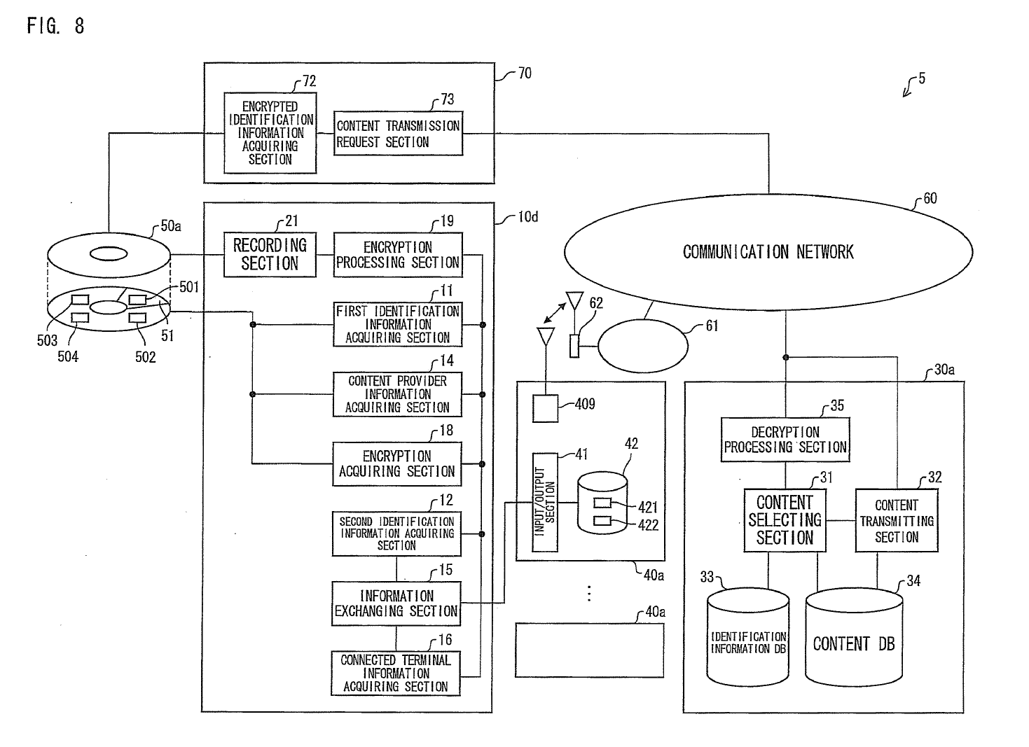

FIG. 8 is a block diagram showing how a content providing system is configured in Embodiment 7. Members that are similar to those of Embodiments 1 through 6 are given identical reference numerals, and are not described in detail.

For example, in a case where the information reproduction device 10d which a user owns does not need to be connected with a communication network 60 and is therefore not in a network environment, a content can be supplied to the terminal device 40a by using the information reproduction device 70 connected to the communication network 60.

According to Embodiment 7, the terminal device identification information 421 and the content identification information 501 that are acquired from the recording medium 50a by the information reproduction device 70 are encrypted, and can therefore be decrypted only by the content providing device 30 having a decryption key. Accordingly, there is no fear that the terminal device identification information 421 and the content identification information 501 are read out, even if a user uses an information reproduction device, such as a personal computer in an Internet cafe, that has a high risk of information leaks.

As shown in FIG. 8, the information reproduction device 10d acquires (i) the terminal device identification information 421 from the terminal device 40a and (ii) the content identification information 501 from the recording medium 50a, and then encrypts the terminal device identification information 421 and the content identification information 501. Then, the information reproduction device 10d records, on the RE layer of the recording medium 50a, encrypted terminal device identification information 421 and encrypted content identification information 501.

Meanwhile, the information reproduction device 70 acquires, from the recording medium 50a, the encrypted terminal device identification information 421 and the encrypted content identification information 501, and then notifies the content providing device 30a of the encrypted terminal device identification information 421 and the encrypted content identification information 501.

Note that the encrypted terminal device identification information 421 and the encrypted content identification information 501 can be recorded in a rewritable medium that is provided separately from the recording medium 50a. In this case, the information reproduction device 70 acquires, from the rewritable medium that is provided separately from the recording medium 50a, the encrypted terminal device identification information 421 and the encrypted content identification information 501.

FIG. 8 illustrates a configuration in which the content providing device 30a directly supplies a relevant content to the terminal device 40a. Embodiment 7 is not, however, limited to this. An alternative configuration can be employed in which the information reproduction device 70 receives a relevant content from the content providing device 30a, records the relevant content on the recording medium 50a, and transfers the relevant content to the terminal device 40a via the information reproduction device 10d.

The present invention is not limited to Embodiments 1 through 7, but can be altered by a skilled person in the art within the scope of the claims. An embodiment derived from a proper combination of technical means disclosed in different Embodiments is encompassed in the technical scope of the present invention.

Finally, the blocks of the information reproduction device 10 may be realized by way of hardware or software as executed by a CPU as follows:

The information reproduction device 10 include a CPU (central processing unit) and memory devices (memory media). The CPU (central processing unit) executes instructions in control programs realizing the functions. The memory devices include a ROM (read only memory) which contains programs, a RAM (random access memory) to which the programs are loaded, and a memory containing the programs and various data. The objective of the present invention can also be achieved by mounting to the information reproduction device 10 a computer-readable storage medium containing control program code (executable program, intermediate code program, or source program) for the information reproduction device 10, which is software realizing the aforementioned functions, in order for the computer (or CPU, MPU) to retrieve and execute the program code contained in the storage medium.

The storage medium may be, for example, a tape, such as a magnetic tape or a cassette tape; a magnetic disk, such as a Floppy (Registered Trademark) disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

The information reproduction device 10 may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth (Registered Trademark), 802.11 wireless, HDR, mobile telephone network, satellite line, or terrestrial digital network. The present invention encompasses a computer data signal embedded in a carrier wave in which the program code is embodied electronically.

Note that the present invention, can be expressed as follows. That an information recording medium recording/reproducing device of the present invention is an information recording medium recording/reproducing device which reproduces medium identification information recorded on an information recording medium, the information recording medium recording/reproducing device including information exchanging means that is capable of exchanging information with an external device; and means for acquiring device identification information intrinsic to the external device at the time of the exchange of the information.

It is preferable that the information recording medium recording/reproducing device is an information recording medium recording/reproducing device which includes means for connection with a network; and means for transmitting the medium identification information and the device identification information to a destination on the basis of destination information recorded on the information recording medium.

It is preferable that the information recording medium recording/reproducing device is an information recording medium recording/reproducing device which includes means for recording the device identification information on a predetermined region of a recordable region of the information recording medium which has the recordable region on which information can be recorded and a reproduction-only region which allows only readout of information.

A recording medium of the present invention is an information recording medium on/from which information can be recorded/reproduced by the information recording medium recording/reproducing device and which has a recordable region on which information can be recorded and a reproduction-only region which allows only readout of information, the reproduction-only region having communication information recorded thereon which is for acquiring a content and information relevant to the content via communication, and the recordable region having a device identification information recording region on which the device identification information is recorded.

It is preferable that the information recording medium recording/reproducing device is an information recording medium recording/reproducing device that is capable of recording/reproducing information on/from the information recording medium having means for connection with a network and transmits only information recorded on the device identification information recording region on the basis of the communication information recorded on the reproduction-only region.

It is preferable that the information recording medium recording/reproducing device is an information recording medium recording/reproducing device that is capable of recording/reproducing information on/from the information recording medium in which means that is capable of encrypting information is recorded on the reproduction-only region, and encrypts, when recording the device identification information on the device identification information recording region, the device identification information on the basis of an encrypting method recorded on the reproduction-only region.

The information reproduction device is preferably arranged such that the first content and the first identification information are recorded on a content storage region, and the first identification information acquiring means is capable of acquiring the first identification information from the content storage region.

In this case, the first content and the first identification information which are distributed via a network or the like can be recorded on the information reproduction device.

This makes it unnecessary for a user to own a recording medium separately, thereby improving convenience for a user.

The information reproduction device is preferably arranged such that content recording medium reproducing means is provided as the first identification information acquiring means, the content, recording medium reproducing means being capable of reproducing a portable content recording medium having a region unrewritable arbitrarily by the user on which region the first content and the first identification information are recorded.

In this case, since the first identification information is recorded on the region that is unrewritable arbitrarily by a user, it is possible to prevent the first identification information from being falsified arbitrarily during the course of distribution of the recording medium, i.e., before the recording medium is delivered to the user.

The information reproduction device is preferably arranged such that the first identification information is pieces of distributed content identification information that are given to respective pieces of distributed first content, and the first identification information acquiring means acquires the pieces of distributed content identification information.

In this case, since the distributed content identification information that is given every time the first content is distributed or sold is used as the first identification information, it is possible to restrict the number of pieces of second identification information associated with a single piece of distributed content identification information. As a result, it is possible to reduce opportunities of illegal copying of the second content.

The information reproduction device is preferably arranged to further include information exchanging means for exchanging information with a terminal device that is provided separately from the reproduction device, the receiving device being the terminal device, the second identification information being terminal identification information for identifying the terminal device, and the second identification information acquiring means acquiring the terminal identification information via the information exchanging means.

In this case, the second content can be reproduced in a terminal device that is separate from the information reproduction device.

This allows a user to carry the terminal device and to reproduce the second content whenever and wherever he or she wants, thereby improving convenience for the user.

The information reproduction device is preferably arranged to further include network communication means for communicating with the content providing device which provides the second content via a communication network, the information notification means being caused to serve as the network communication means, the network communication means notifying the content providing device of the first identification information and the second identification information.

In this case, since the information reproduction device includes the network communication means that is capable of communicating with the content providing device, the information reproduction device can automatically carry out an operation of notifying the content providing device of the first identification information and the second identification information.

This reduces user's workload, thereby improving convenience for the user.

The information reproduction device is preferably arranged such that there is provided, as the first identification information acquiring means, information exchanging means for exchanging information with a first content reproduction device that is provided separately from the information reproduction device and that is capable of reading out the first content and the first identification information.

In this case, the information reproduction device does not need to read out the first content and the first identification information. Accordingly, for example, a mobile terminal can be used as the information reproduction device.

This allows a user to carry the mobile terminal and to notify the content providing device of the first identification information and the second identification information whenever and wherever he or she wants. As a result, convenience for the user improves.

Further, the first content reproduction device does not need to have communication means.

Accordingly, a user does not need to pay an extra cost for giving communication means to the first content reproduction device.

The information reproduction device is preferably arranged such that the information output means is identification information recording medium recording means for recording, on a portable identification information recording medium, the first identification information and the second identification information.

In this case, since the first identification information and the second identification information are recorded on the identification information recording medium, it is possible to cause information notification means that is separately provided from the information reproduction device to (i) read in the two types of identification information via the identification information recording medium and (ii) notify the content providing device of the first identification information and the second identification information.

Accordingly, the information reproduction device does not need to have communication means for notifying the content providing device of the two types of identification information. Consequently, a user does not need to pay an extra cost for giving communication means to the information reproduction device.

The information reproduction device is preferably arranged such that the receiving device is capable of communicating with the content providing device via a communication network, the information reproduction device further including: connected receiving device information acquiring means for acquiring connected receiving device information from the receiving device via the second identification information acquiring means, the connected receiving device information specifying the receiving device to which a connection is to be made on the communication network, and the information output means further supplies, to the information notification means, the connected receiving device information, acquired by the connected receiving device information acquiring means.

In this case, the content providing device can provide the second content directly to the receiving device with the use of the connected receiving device information.

Accordingly, it becomes unnecessary for a user to carry out an operation of transferring the second content to the receiving device. This reduces user's workload, thereby improving convenience for the user.

The information reproduction device is preferably arranged such that the information output means deletes the first identification information and the second identification information from the information reproduction device after outputting the first identification information and the second identification information.

In this case, the first identification information and the second identification information do not remain in the information reproduction device. Accordingly, even if the information reproduction device is stolen, etc., there is no possibility that the first identification information and the second identification information are illegally read from the information reproduction device by a third party.

The information reproduction device is preferably arranged such that the information output means instructs the information notification means to delete the first identification information and the second identification information after notifying the content providing device of the first identification information and the second identification information.

In this case, the first identification information and the second identification information do not remain in the information notification means. Accordingly, there is no possibility that the first identification information and the second identification information are illegally read from the identification information acquiring means by a third party.

The information reproduction device is preferably arranged such that the content recording medium has a recordable region in which information is recordable, and the second identification information is recorded on the recordable region.

In this case, since the second identification information is recorded on the content recording medium, it is unnecessary to acquire the second identification information again when a new second content becomes available and the second identification information becomes unnecessary.

This makes the user's operation easy, thereby improving convenience for the user.

Further, since the second identification information is recorded on the content recording medium, it is possible to cause information notification means that is separately provided from the information reproduction device to (i) read in the two types of identification information via the content recording medium and (ii) notify the content providing device of the first identification information and the second identification information.

Accordingly, the information reproduction device does not need to have communication means for notifying the content providing device of the two types of identification information. Consequently, a user does not need to pay an extra cost for giving communication means to the information reproduction device.

The information reproduction device is preferably arranged such that an encryption key and an encryption algorism are recorded on the region unrewritable arbitrarily by the user which region the content recording medium has, and the information reproduction device acquires the encryption key and the encryption algorism from the content recording medium, and records, on the recordable region, the second identification information that has been encrypted.

In this case, it is unnecessary to separately prepare the encryption key and the encryption algorism. This reduces user's workload, thereby improving convenience for the user.

Further, since the encryption key and the encryption algorism are recorded on the region that is unrewritable arbitrarily by a user, it is possible to prevent the encryption key and the encryption algorism from being falsified arbitrarily during the course of distribution of the recording medium, i.e., before the recording medium is delivered to the user.

Further, since the second identification information having been recorded is encrypted, there is no possibility of leakage of the second identification information even if the content medium is stolen etc.

The information reproduction device is preferably arranged such that the information output means outputs the first identification information and the second identification information after the first identification information or the second identification information is encrypted by use of an encryption key and an encryption algorism.

In this case, there is no risk of illegal read-out and misuse of the first identification information and the second identification information outputted by the information output means.

The information reproduction device is preferably arranged to further include encryption acquiring means for acquiring the encryption key and the encryption algorism for encrypting the first identification information and the second identification information with use of the encryption key, the encryption acquiring means acquiring the encryption key and the encryption algorism that are recorded together with the first content.

In this case, it is unnecessary to separately prepare the encryption key and the encryption algorism. This reduces user's workload, thereby improving convenience for the user.

The information reproduction device is preferably arranged such that in a case where the first identification information or the second identification information which is acquired with use of the first identification information acquiring means or the second identification information acquiring means, respectively, is encrypted, the information reproduction device has a decryption key and a decryption algorism for decrypting the first identification information or the second identification information.

In this case, the first identification information and the second identification information are transferred by the first identification information acquiring means and the second identification information acquiring means with the use of codes, respectively, it is possible to prevent the first and second identification information from being forged, counterfeited, and falsified with the use of an intermediary device or the like.

The information reproduction device is preferably arranged to further include content provider information acquiring means for acquiring content provider information that is recorded together with the first content, the content provider information specifying the content providing device to which a connection is to be made, the information output means outputting the content provider information acquired with use of the content provider information acquiring means, in addition to the first identification information and the second identification information.

In this case, it is unnecessary to separately acquire the content provider information for specifying the content providing device, and it is possible to acquire the content provider information together with the first content.

This reduces user's workload, thereby improving convenience for the user.

The content recording medium is preferably arranged such that an encryption key and an encryption algorism are recorded in the region of the content recording medium, which region is unrewritable arbitrarily by the user.

In this case, it is unnecessary to separately prepare the encryption key and the encryption algorism. This reduces user's workload, thereby improving convenience for the user.

Further, since the encryption key and the encryption algorism are recorded on the region that is unrewritable arbitrarily by a user, it is possible to prevent the encryption key and the encryption algorism from being falsified arbitrarily during the course of distribution of the recording medium, i.e., before the recording medium is delivered to the user.

Further, since the second identification information having been recorded is encrypted, there is no possibility of leakage of the second identification information even if the content medium is stolen etc.

The content providing system is preferably arranged such that the first identification information is pieces of distributed content identification information that are given to respective pieces of distributed first content, the first identification information acquiring means of the information reproduction device acquires the pieces of distributed content identification information, and the content providing device further includes an identification information database in which the pieces of distributed content identification information and pieces of second identification information are stored so as to be associated with each other.

In this case, since the distributed content identification information that is given every time the first content is distributed or sold is used as the first identification information, it is possible to restrict the number of pieces of second identification information associated with a single piece of distributed content identification information in the identification information database of the content providing device. As a result, it is possible to reduce opportunities of illegal copying of the second content.

The content providing system is preferably arranged such that the information reproduction device further includes information exchanging means for exchanging information with a terminal device which is provided separately from the information reproduction device, the receiving device is the terminal device, the second identification information is terminal identification information for identifying the terminal device, and the second identification information acquiring means acquires the terminal identification information via the information exchanging means.

In this case, the second content can be reproduced in a terminal device that is separate from the information reproduction device.

This allows a user to carry the terminal device and to reproduce the second content whenever and wherever he or she wants, thereby improving convenience for the user.

The content providing system is preferably arranged such that the information reproduction device further includes network communication means for communicating with the content providing device which provides the second content via the communication network, the information notification means is caused to serve as the network communication means, and the network communication means notifies the content providing device of the first identification information and the second identification information.

In this case, since the information reproduction device includes the network communication means that is capable of communicating with the content providing device, the information reproduction device can automatically carry out an operation of notifying the content providing device of the first identification information and the second identification information.

This reduces user's workload, thereby improving convenience for the user.

The content providing system is preferably arranged such that in the information reproduction device, there is provided, as the first identification information acquiring means, information exchanging means for exchanging information with a first content reproduction device that is provided separately from the information reproduction device and that is capable of reading out the first content and the first identification information.

In this case, the information reproduction device does not need to read out the first content and the first identification information. Accordingly, for example, a mobile terminal can be used as the information reproduction device.

This allows a user to carry the mobile terminal and to notify the content providing device of the first identification information and the second identification information whenever and wherever he or she wants. As a result, convenience for the user improves.

Further, the first content reproduction device does not need to have communication means.

Accordingly, a user does not need to pay an extra cost for giving communication means to the first content reproduction device.

The content providing system is preferably arranged such that the information output means of the information reproduction device is identification information recording medium recording means for recording the first identification information and the second identification information on an identification information recording medium that is portable by a user, the information notification means includes identification information recording medium reproducing means for reproducing the identification information recording medium, and the first identification information and the second identification information recorded on the identification information recording medium are reproduced with use of the identification information recording medium reproducing means, and are then supplied to the content providing device.

In this case, since the first identification information and the second identification information are recorded on the identification information recording medium, it is possible to cause information notification means that is separately provided from the information reproduction device to (i) read in the two types of identification information via identification information recording medium and (ii) notify the content providing device of the first identification information and the second identification information.

Accordingly, the information reproduction device does not need to have communication means for notifying the content providing device of the two types of identification information. Consequently, a user does not need to pay an extra cost for giving communication means to the information reproduction device.

The content providing system is preferably arranged such that the information notification means further includes identification information recording medium recording means for recording information on the identification information recording medium, and the second content provided by the content providing device is recorded on the identification information recording medium with use of the identification information recording medium recording means.

In this case, neither the information reproduction device nor the receiving device need to be connected to the content providing device via the communication network. Accordingly, a user does not need to pay an extra cost for giving communication means to the information reproduction device and the receiving device.

The content providing system is preferably arranged such that the receiving device is capable of communicating with the content providing device via the communication network, the information reproduction device further includes connected receiving device information acquiring means for acquiring connected receiving device information from the receiving device via the second identification information acquiring means, the connected receiving device information specifying the receiving device to which a connection is to be made on the communication network, the information output means further supplies, to the information notification means, the connected receiving device information acquired by the connected receiving device information acquiring means, and the content providing device directly transmits the second content to the receiving device with use of the connected receiving device information.

In this case, the content providing device can directly provide the second content to the receiving device with the use of the connected receiving device information.

Accordingly, it becomes unnecessary for a user to carry out an operation of transferring the second content to the receiving device. This reduces user's workload, thereby improving convenience for the user.

The content providing system is preferably arranged such that the content providing device directly receives the second identification information from the receiving device with use of the connected receiving device information, and the content providing device directly transmits the second content to the receiving device with use of the connected receiving device information after matching (i) the second identification information supplied by the information notification means with (ii) the second identification information directly received from the receiving device.

In this case, the content providing device can directly confirm that the receiving device which provides the second content coincides with the receiving device whose identification information has been supplied by the information notification means. This makes it possible to reduce opportunities of illegal copying of the second content.

The content providing system is preferably arranged such that the information reproduction device supplies the first identification information and the second identification information to the information notification means with use of the information output means after encrypting the first identification information or the second identification information with use of an encryption key and an encryption algorism, and the content providing device further includes decryption processing means for decrypting, with use of a decryption key, the first identification information and the second identification information that have been encrypted.

In this case, there is no risk of illegal read-out and misuse of the first identification information and the second identification information outputted by the information output means.

The content providing system is preferably arranged such that the first content and the first identification information are recorded in a region of a content recording medium that is portable by a user, which region is unrewritable arbitrarily by the user, the information reproduction device further includes: content recording medium reproducing means for reproducing the content recording medium; and encryption acquiring means for acquiring (i) the encryption key and (ii) the encryption algorism for encrypting the first identification information and the second identification information with use of the encryption key, the encryption key and the encryption algorism are recorded in the region of the content recording medium which region is unrewritable arbitrarily by the user, and the encryption acquiring means acquires, with use of the content recording medium reproducing means, the encryption key and the encryption algorism recorded on the content recording medium.

In this case, since the first identification information, the encryption key, and the encryption algorism are recorded on the region that is unrewritable arbitrarily by a user, it is possible to prevent the first identification information, the encryption key, and the encryption algorism from being falsified arbitrarily during the course of distribution of the recording medium, i.e., before the recording medium is delivered to the user.

In this case, it is unnecessary to separately prepare the encryption key and the encryption algorism. This reduces user's workload, thereby improving convenience for the user.

The content providing system is preferably arranged such that the second content provided by the content providing device is reproducible only in the receiving device having the second identification information supplied by the information notification means.

In this case, the second content provided by the content providing device cannot be reproduced in a receiving device, other than the receiving device whose identification information has been supplied by the information notification means. This makes it possible to reduce opportunities of illegal copying of the second content.

The information reproduction device may be realized by a computer. In this case, the scope of the present invention encompasses a control program for the information reproduction device which control program causes a computer to operate as each means of the information reproduction device so that the information reproduction device is realized by the computer.

### INDUSTRIAL APPLICABILITY

The present invention makes it possible to improve convenience for a user and to prevent illegal copying of a content from a recording medium such as a content DVD or a content BD. Accordingly, the present invention is suitably applicable to an information reproduction device used by the user which has a communication function.

### REFERENCE SIGNS LIST

1, 2, 3, 4, 5, 6: Content providing system
10, 70: Information reproduction device.
11: First identification information acquiring section (first identification information acquiring means, content recording medium reproducing means, identification information recording medium reproducing means, recording medium identification information acquiring means)
12: Second identification information acquiring section (second identification information acquiring means, terminal device identification information acquiring means)
13, 13a, 13b: Content transmission request section (information output means, information notification means, network communication means)
14: Content provider information acquiring section (content provider information acquiring means)
15: Information exchanging section (information exchanging means)
16: Connected terminal information (connected receiving device information acquiring means)
17: User information setting section
18: Encryption acquiring section (encryption acquiring means)
19: Encryption processing section
21: Recording section (identification information recording medium recording means)
22, 22b: Encrypted identification information acquiring section
30: Content providing device (relevant program providing device)
31: Content selecting section
32: Content transmitting section
33: Identification information database
34: Content database
35: Decryption processing section (decryption processing means)
40: Terminal device (receiving device)
41: Input/output section
42: Terminal device identification information storage region
421: Terminal device identification information (second identification information, terminal identification information)
422: Connected terminal information (connected receiving device information)
50, 50a: Recording medium (content recording medium, identification information recording medium)
51: Content identification information storage region
60: Communication network
61: Data communication network
62: Wireless base station
80: Information reproduction device (first content reproduction device)
501: Content identification information (first identification information)
502: Content provider information
503: Encryption key
504: Encryption algorism

1. (canceled)

2. A method for providing content with use of an information reproduction device that is capable of reproducing information, said method comprising the steps of:
(a) notifying a content providing device, having a plurality of pieces of content, of (i) content identification information, which is unrewritable arbitrarily by a user, for identifying first content and (ii) receiving device identification information, which is unrewritable arbitrarily by a user, for identifying a receiving device that receives second content relevant to the first content;
(b) acquiring the content identification information from a portable content recording medium having a region unrewritable arbitrarily by the user on which region the first content and the content identification information are recorded;
(c) acquiring the receiving device identification information; and
(d) preventing the second content, which is specified based on the content identification information and the receiving device identification information, from being illegally copied onto a receiving device other than the receiving device identified by the receiving device identification information.

3. An information reproduction device that is capable of reproducing information, comprising:
an information notification section for notifying a content providing device, having a plurality of pieces of content, of (i) content identification information, which is unrewritable arbitrarily by a user, for identifying first content and (ii) receiving device identification information, which is unrewritable arbitrarily by a user, for identifying a receiving device that receives second content relevant to the first content;
a content identification information acquiring section for acquiring the content identification information;
a receiving device identification information acquiring section for acquiring the receiving device identification information from a content recording medium; and
an illegal copying prevention section for preventing the second content, which is specified based on the content identification information and the receiving device identification information, from being illegally copied onto a receiving device other than the receiving device identified by the receiving device identification information,
as the content identification information acquiring section, a content recording medium reproducing section being provided which is capable of reproducing the content recording medium, which is portable by a user and has a region unrewritable arbitrarily by the user on which region the first content and the content identification information are recorded.
